(19) United States
(12) Patent Application Publication
(10) Pub. No.: US 2021/0075779 A1
(43) Pub. Date: Mar. 11, 2021

(54) INFORMATION PROCESSING METHOD AND SYSTEM

(71) Applicant: YUNDING NETWORK TECHNOLOGY (BEIJING) CO., LTD., Beijing (CN)

(72) Inventors: Guoliang LI, Beijing (CN); Qi YI, Beijing (CN); Lifeng LIU, Beijing (CN); Lei WANG, Beijing (CN); Canjin GAO, Beijing (CN)

(73) Assignee: YUNDING NETWORK TECHNOLOGY (BEIJING) CO., LTD., Beijing (CN)

(21) Appl. No.: 17/100,886

(22) Filed: Nov. 22, 2020

Related U.S. Application Data
(63) Continuation of application No. PCT/CN2019/088035, filed on May 22, 2019.

(30) Foreign Application Priority Data
May 22, 2018 (CN) 201810493326.0
Jul. 9, 2018 (CN) 201810744405.4

(51) Int. Cl. H04L 29/06; G07C 9/00; G07C 9/38; G06Q 50/16; G06Q 30/00; G05B 19/042

(52) U.S. Cl. CPC H04L 63/083; G07C 9/00904; G07C 9/38; G06Q 30/0645; G06Q 30/018; G05B 19/042; G06Q 50/163

(57) ABSTRACT

The present disclosure provides methods and systems for information processing. The method may include obtaining object information of at least one object and user information of at least one authorized user; establishing a corresponding relationship between the object information of the at least one object and the user information of the at least one authorized user; determining, based to the corresponding relationship, a first object corresponding to user information of a first authorized user among the at least one authorized user; and sending the user information of the first authorized user to the first object, enabling the first object to verify information of an operator of the first object based on the user information of the first authorized user and processing an operation request of the operator based on a verification result.

### CROSS-REFERENCE TO RELATED APPLICATION

This application is a Continuation of International Application No. PCT/CN2019/088035 filed on May 22, 2019, which claims priority of Chinese Patent Application No. 201810744405.4 filed on Jul. 9, 2018, and Chinese Patent Application No. 201810493326.0 filed on May 22, 2018, the contents of each of which are hereby incorporated by reference in its entirety.

### TECHNICAL FIELD

The present disclosure relates to the field of information processing, in particular to methods and systems for management and verification of identity information.

### BACKGROUND

With the rapid development of Internet technology, management, sales, and lease of objects based on Internet platforms are becoming more and more extensive. On one hand, object management parties (e.g., public rental housing centers, talent apartment centers, hotel customer supervision, etc.) need to monitor and verify user identity information. On the other hand, it is also necessary to ensure safety of objects.

Therefore, the present disclosure provides methods for management and verification of identity information based on biometric information to improve supervision efficiency of the management, sales, or lease of the object.

### SUMMARY

One aspect of the present disclosure provides a method for processing information. The method may include obtaining object information of at least one object and user information of at least one authorized user; establishing a corresponding relationship between the object information of the at least one object and the user information of the at least one authorized user; determining, based to the corresponding relationship, a first object corresponding to user information of a first authorized user among the at least one authorized user; and sending the user information of the first authorized user to the first object, enabling the first object to verify information of an operator of the first object based on the user information of the first authorized user and processing an operation request of the operator based on a verification result.

In some embodiments, the user information may include identity verification information of the authorized user.

In some embodiments, the user information may further include permission information. The permission information may be configured to define at least one of a function of the identity verification information, a service time range of the identity verification information, or a state of the identity verification information.

In some embodiments, the object may include a lockset and the operation request may include an unlock request.

In some embodiments, the method may further include updating the user information of the first authorized user, and sending the updated user information of the first authorized user to the first object to update the user information of the first authorized user existing in the first object.

Another aspect of the present disclosure provides a system for processing information. The system may include an obtaining module configured to obtain object information of at least one object and user information of at least one authorized user; a corresponding relationship establishment module configured to establish a corresponding relationship between the object information of the at least one object and the user information of the at least one authorized user; a first object determination module configured to determine, based to the corresponding relationship, a first object corresponding to user information of a first authorized user among the at least one authorized user; and a sending module configured to send the user information of the first authorized user to the first object, enabling the first object to verify information of an operator of the first object based on the user information of the first authorized user and processing an operation request of the operator based on a verification result.

Another aspect of the present disclosure provides a device for processing information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides a computer-readable storage medium. The storage medium may store computer instructions that, when the computer instructions read by a computer, direct the computer to perform any operation of the method for information processing.

Another aspect of the present disclosure provides a method for information processing. The method may include obtaining object information of at least one object and user information of at least one authorized user; establishing a corresponding relationship between the object information of the at least one object and the user information of the at least one authorized user; determining, based on the corresponding relationship, a first object corresponding to user information of a first authorized user among the at least one authorized user; receiving an operation request of an operator of the first object and information of the operator; and verifying the information of the operator based on the user information of the first authorized user and processing the operation request based on a verification result.

Another aspect of the present disclosure provides a system for information processing. The system may include an information obtaining module configured to obtain object information of at least one object and user information of at least one authorized user; a corresponding relationship establishment module configured to establish a corresponding relationship between the object information of the at least one object and the user information of the at least one authorized user; a first object determination module configured to determine, based to the corresponding relationship, a first object corresponding to user information of a first authorized user among the at least one authorized user; a receiving module configured to receive an operation request of an operator of the first object and information of the operator; an operation verification module configured to verify the information of the operator based on the user information of the first authorized user; and an operation execution module configured to process the operation request based on a verification result.

Another aspect of the present disclosure provides a device for processing information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides a computer-readable storage medium. The storage medium may store computer instructions that, when the computer instructions read by a computer, direct the computer to perform any operation of the method for information processing.

Another aspect of the present disclosure provides another method for information processing. The method may include obtaining object information of at least one object and user information of at least one authorized user; establishing a corresponding relationship between the object information of the at least one object and the user information of the at least one authorized user; determining, based on the corresponding relationship, a first object corresponding to user information of a first authorized user among the at least one authorized user; receiving an operation request of an operator of the first object and information of the operator; and verifying the information of the operator based on the user information of the first authorized user and processing the operation request based on a verification result.

In some embodiments, the user information of the first authorized user includes identity verification information of the authorized user.

In some embodiments, the information of the operator includes identity verification information of the operator. The verifying the information of the operator based on the user information of the first authorized user and processing the operation request based on a verification result may include verifying whether the identity verification information of the operator matches the identity verification information of the first authorized user; and in response to that the identity verification information of the operator matches the identity verification information of the first authorized user, controlling the first object to execute an operation requested by the operation request.

In some embodiments, the information of the operator may include identity verification information of the operator. The method may further include in response to that the identity verification information of the operator does not match the identity verification information of the first authorized user, determining whether a count of times the operation request of the operator of the first object is consecutively receiving exceeds a set count threshold; in response to that the count of times does not exceed the set count threshold, continuing to receive the operation request of the operator of the first object and the information of the operator, and verifying the information of the operator based on the user information of the first authorized user; in response to that the count of times exceeds the set count threshold, generating operation failure information and stopping responding to the operation request of the operator of the first object.

In some embodiments, the method may further include in response to that the count of times the operation request of the operator of the first object is consecutively receiving exceeds the set count threshold, generating alarm information.

In some embodiments, the user information may further include permission information. The permission information may be configured to define at least one of a function of the identity verification information, a service time range of the identity verification information, or a state of the identity verification information.

In some embodiments, the verifying the information of the operator based on the user information of the first authorized user and processing the operation request based on a verification result may include verifying whether identity information of the operator matches the identity verification information of the first authorized user; and in response to that the identity information of the operator matches the identity verification information of the first authorized user, processing the operation request based on the permission information of the authorized user.

In some embodiments, the processing the operation request based on the permission information of the first authorized user may include controlling the first object to execute the operation requested by the operation request when at least one of conditions is satisfied that a receiving time of the operation request is within the service time range of the identity verification information of the first authorized user; the state of the identity verification information of the first authorized user is an enabled state; or the function of the identity verification information of the first authorized user includes a function corresponding to an operation requested by the operation request.

Another aspect of the present disclosure provides another system for information processing. The system may include an information obtaining module configured to obtain object information of at least one object and user information of at least one authorized user; a corresponding relationship establishment module configured to establish a corresponding relationship between the object information of the at least one object and the user information of the at least one authorized user; a first object determination module configured to determine, based to the corresponding relationship, a first object corresponding to user information of a first authorized user among the at least one authorized user; a receiving module configured to receive an operation request of an operator of the first object and information of the operator; an operation verification module configured to verify the information of the operator based on the user information of the first authorized user; and an operation execution module configured to process the operation request based on a verification result.

Another aspect of the present disclosure provides another device for processing information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides another computer-readable storage medium. The storage medium may store computer instructions that, when the computer instructions read by a computer, direct the computer to perform any operation of the method for information processing.

Another aspect of the present disclosure provides another method for processing information. The method may include receiving an operation request including identity verification information of a user; determining preset identity verification information that matches the identity verification information of the user; obtaining permission information of the preset identity verification information, the permission information being configured to define at least one of a function of the preset identity verification information, a service time range of the preset identity verification information, or a state of the preset identity verification information; and processing the operation request based on the permission information of the preset identity verification information.

In some embodiments, the processing the operation request based on the permission information of the preset identity verification information includes executing an operation requested by the operation request when at least one of conditions is satisfied that a receiving time of the operation request is within the service time range of the preset identity verification information; the state of the preset identity verification information is an enabled state; or the function of the preset identity verification information includes a function corresponding to an operation requested by the operation request.

In some embodiments, the method may further include receiving pending permission information of the preset identity verification information; determining whether the pending permission information satisfies a preset requirement; in response to that the pending permission information satisfies the preset requirement, determining the pending permission information to be the permission information of the preset identity verification information.

In some embodiments, the method may further include in response to that the permission information of the matched preset identity information satisfies a condition, obtaining all preset identity verification information; for each of at least a portion of all the preset identity verification information, determining whether a current time is within the service time range of the preset identity verification information; in response to that the current time is not within the service time range of the preset identity verification information, updating the state of the preset identity verification information to be a disabled state.

Another aspect of the present disclosure provides another system for processing information. The system may include an operation receiving module configured to receive an operation request carrying including identity verification information of a user; an identity verification module configured to determine preset identity verification information that matching matches the identity verification information of the user; a permission obtaining module configured to obtain permission information of the preset identity verification information, the permission information being configured to define at least one of a function of the preset identity verification information, a service time range of the preset identity verification information, or a state of the preset identity verification information; an operation execution module configured to process the operation request based on the permission information of the preset identity verification information.

Another aspect of the present disclosure provides another device for processing information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides another computer-readable storage medium. The storage medium may store computer instructions that, when the computer instructions read by a computer, direct the computer to perform any operation of the method for information processing.

Another aspect of the present disclosure provides a method for setting identity verification information. The method may include sending an input instruction for the identity verification information to an object; in response to that the object inputs the identity verification information, sending permission information corresponding to the identity verification information and a saving instruction to the object, the saving instruction enabling the object to save the inputted identity verification information and the corresponding permission information; wherein the permission information may be configured to define at least one of a function of the identity verification information, a service time range of the identity verification information, or a state of the identity verification information.

In some embodiments, the method may further include sending the identity verification information and the corresponding updated permission information to the object, enabling the object to update the saved permission information of the identity verification information.

Another aspect of the present disclosure provides a system for setting identity verification information. The system may include an input instruction module configured to send an input instruction for the identity verification information to an object; a save instruction module configured to, in response to that the object inputs the identity verification information, send the permission information corresponding to the identity verification information and a saving instruction to the object, the saving instruction enabling the object to save the inputted identity verification information and the corresponding permission information; wherein the permission information may be configured to define at least one of a function of the identity verification information, a service time range of the identity verification information, or a state of the identity verification information.

Another aspect of the present disclosure provides a device for setting identity verification information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides another computer-readable storage medium. The storage medium may store computer instructions that, when the computer instructions read by a computer, direct the computer to perform any operation of the method for information processing.

Another aspect of the present disclosure provides another method for setting identity verification information. The method may include receiving an input instruction for the identity verification information sent by a server; in response to the input instruction, acquiring the identity verification information; receiving permission information corresponding to the identity verification information and a saving instruction sent by the server, and saving the inputted identity verification information and the corresponding permission information.

In some embodiments, the method may further include receiving the identity verification information sent by the server and the corresponding updated permission information; and updating the stored permission information of the identity verification information based on the updated permission information.

Another aspect of the present disclosure provides another system for setting identity verification information. The system may include a receiving module configured to receive an input instruction for the identity verification information sent by a server; an acquisition module configured to, in response to the input instruction, acquire the identity verification information; the receiving module further configured to receive permission information corresponding to the identity verification information and a saving instruction sent by the server; and a save module configured to save the inputted identity verification information and the corresponding permission information.

Another aspect of the present disclosure provides another device for setting identity verification information. The device may include at least one processor and at least one storage. The at least one storage may be configured to store computer instructions. The at least one processor may be configured to execute at least a portion of the computer instructions to implement any operation of the method for information processing.

Another aspect of the present disclosure provides another computer-readable storage medium. The storage medium may store computer instructions that, when the computer instructions read by a computer, direct the computer to perform any operation of the method for information processing.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures, and wherein:

FIG. 1 is a schematic diagram illustrating an exemplary system for information processing according to some embodiments of the present disclosure;

FIG. 2 is a schematic flowchart illustrating an exemplary process for information processing according to some embodiments of the present disclosure;

FIG. 3 is a schematic flowchart illustrating an exemplary process for establishing a corresponding relationship between identification information of an object and user information of an authorized user according to some embodiments of the present disclosure;

FIG. 4 is a block diagram illustrating an information processing system according to some embodiments of the present disclosure;

FIG. 5 is a schematic flowchart illustrating an exemplary process for information processing according to some embodiments of the present disclosure;

FIG. 6 is a block diagram illustrating an information processing system according to some embodiments of the present disclosure;

FIG. 7 is a schematic flowchart illustrating an exemplary process for information processing according to some embodiments of the present disclosure;

FIG. 8 is a schematic flowchart illustrating an exemplary process for processing an operation request according to some embodiments of the present disclosure;

FIG. 9 is a schematic flowchart illustrating an exemplary process for updating permission information of identity verification information according to some embodiments of the present disclosure;

FIG. 10 is a schematic flowchart illustrating an exemplary process for generating permission information according to some embodiments of the present disclosure; and

FIG. 11 is a block diagram illustrating an information processing system according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

It will be understood that the term “system,” “engine,” “unit,” and/or “module” used herein are one method to distinguish different components, elements, parts, sections, or assembly of different levels in ascending order. However, the terms may be displaced by another expression if they achieve the same purpose.

As used in the disclosure and the appended claims, the singular forms “a,” “an,” and “the” may include plural referents unless the content clearly dictates otherwise. In general, the terms “comprise” and “include” merely prompt to include steps and elements that have been clearly identified, and these steps and elements do not constitute an exclusive listing. The methods or devices may also include other steps or elements.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

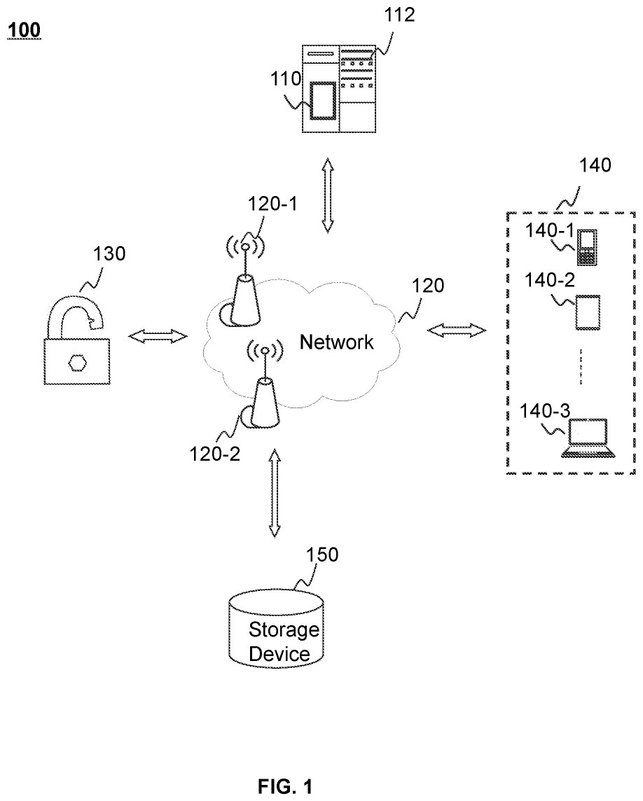

FIG. 1 is a schematic diagram illustrating an exemplary system for information processing according to some embodiments of the present disclosure.

The information processing system 100 may perform operations, such as, performing unified management of a plurality of objects, registering and updating information of authorized users, processing operation requests of operators, etc. The information processing system 100 may be configured to manage various objects including movable properties and real properties. For example, the real property may include a room, etc., and the movable property may include a vehicle, a locker, an electrical appliance, etc. An object may be equipped with a control device, such as a lockset, a speed control device, an electrical switch, etc., to control the object according to the operation request of the user. The information processing system 100 may include a server 110, a network 120, an object 130, a user terminal 140, and a storage device 150.

The server 110 may process data and/or information from at least one component of the information processing system 100. For example, information of an operator and an operation request acquired by the object 130 may be sent to the server 110. As another example, an administrator of the object 130 may register object information and the identity of an authorized user on the user terminal 140. The registered information may be uploaded to the server 110. The server 110 may verify the information of the operator based on the registered information, process the operation request of the operator based on a verification result, and send the processing result to the object 130.

In some embodiments, the server 110 may be a single processing device or a group of processing devices. The group of processing devices may be a centralized group of processing devices connected to the network 120 via an access point, or a distributed group of processing devices respectively connected to the network 120 via at least one access point. In some embodiments, the server 110 may be locally connected to the network 120 or remotely connected to the network 120. For example, the server 110 may access information and/or data stored in the object 130, the user terminal 140, and/or the storage device 150 via the network 120. As another example, the storage device 150 may be used as a back-end data storage of the server 110. In some embodiments, the server 110 may be implemented on a cloud platform. Merely by way of example, the cloud platform may include a private cloud, a public cloud, a hybrid cloud, a community cloud, a distributed cloud, an internal cloud, a multi-layer cloud, or the like, or any combination thereof.

In some embodiments, the server 110 may include a processing device 112. The processing device 112 may process information and/or data related to at least one function described in the present disclosure. In some embodiments, the processing device 112 may perform main functions of the information processing system 100. For example, the processing device 112 may verify the information of the operator of the object, and process the operation request of the operator based on the verification result. In some embodiments, the processing device 112 may perform other functions related to the methods and systems described in the present disclosure. In some embodiments, the processing device 112 may include at least one processing unit (e.g., a single-core processing device or a multi-core processing device). Merely by way of example, the processing device 112 may include a central processing unit (CPU), an application-specific integrated circuit (ASIC), an application-specific instruction-set processor (ASIP), a graphics processing unit (GPU), a physical processing unit (PPU), a digital signal processor (DSP), a field-programmable gate array (FPGA), a programmable logic device (PLD), a controller, a microcontroller unit, a reduced instruction set computer (RISC), a microprocessor, or the like, or any combination thereof.

The network 120 may facilitate an exchange of the information and/or data. In some embodiments, at least one component of the information processing system 100 (e.g., the server 110, the object 130, the user terminal 140, or the storage device 150) may send the information and/or data to other components of the information processing system 100 via the network 120. For example, the processing device 112 may obtain user information of the authorized user from the storage device 150 via the network 120. As another example, the processing device 112 may send user information of the authorized user to the corresponding object 130.

In some embodiments, the network 120 may be any form of wired or wireless network, or any combination thereof. Merely by way of example, the network 120 may include a cable network, a wired network, an optical fiber network, a telecommunication network, an internal network, the Internet, a local area network (LAN), a wide area network (WAN), a wireless local area network (WLAN), a metropolitan area network (MAN), a public switched telephone network (PSTN), a Bluetooth network, a ZigBee network, a near field communication (NFC) network, or the like, or any combination thereof. In some embodiments, the network 120 may include at least one network access point. For example, the network 120 may include wired or wireless network access points, such as base stations and/or Internet exchange points 120-1, 120-2, . . . , and at least one component of the information processing system 100 may be connected to the network 120 to exchange the data and/or information.

The object 130 may include various types of objects including movable properties and real properties. The object 130 may include a control device for controlling the object 130 based on an operation request of a user (or operator). For example, the object 130 may include a room, which includes a door lock. By using the information processing system 100, an authorized user may use the room, while excluding other people who have no permission from using the room. For instance, the room may include a public rental housing that a tenant is permitted to use, or a hotel room that a hotel guest is allocated to. The authorized tenant or hotel guest may have the permission to use the room that they are permitted or allocated, and other people may not use the room, which may be effective to avoid a risk of subletting or transferring the room. As another example, the object 130 may include a smart electrical appliance, which has a switch. An authorized user may have the permission to turn on the switch to use the electrical appliance, but others may not use it. The object 130 may have a storage device that is used to store user information and a historical operation record of authorized users.

A user may access the information processing system 100 through the user terminal 140. An administrator of one or more objects (e.g., the object 130) may implement the unified management of a plurality of objects through the user terminal 140. For example, the administrator may input the information of an authorized user (i.e., user information) and object information of one of the one or more objects (e.g., the object 130) through the user terminal 140. The administrator may update (including adding, modifying, deleting, invalidating, etc.) the input object information and/or user information besides inputting. The user terminal 140 may include a mobile device 140-1, a tablet computer 140-2, a laptop computer 140-3, or the like, or any combination thereof. In some embodiments, the user terminal 140 may include an electronic computer, a smart home device, a wearable device, a smart mobile device, a virtual reality device, an augmented reality device, or the like, or any combination thereof. In some embodiments, the smart home device may include a smart lighting device, a smart electrical control device, a smart monitoring device, a smart TV, a smart camera, a walkie-talkie, or the like, or any combination thereof. In some embodiments, the wearable device may include a smart bracelet, a smart footwear, smart glasses, a smart helmet, a smartwatch, smart clothes, a smart backpack, a smart accessory, or the like, or any combination thereof. In some embodiments, the smart mobile device may include a smartphone, a personal digital assistant (PDA), a gaming device, a navigation device, a point of sale (POS), or the like, or any combination thereof. In some embodiments, the virtual reality device and/or augmented virtual reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google Glass™, Oculus Rift™, Hololens™, GearVR™, or the like.

The storage device 150 may store data and/or instructions. For example, the information of the authorized user may be stored. In some embodiments, the storage device 150 may store data and/or instructions that may be executed by the processing device 112, and the server 110 may execute or use the data and/or instructions to implement the exemplary method described in the present disclosure. In some embodiments, the storage device 150 may include mass storage, removable storage, a volatile read-write memory, read-only memory (ROM), or the like, or any combination thereof. Exemplary mass storage may include a magnetic disk, an optical disk, a solid-state disk, etc. Exemplary removable storages may include a flash drive, a floppy disk, an optical disk, a memory card, a compact disk, a magnetic tape, etc. Exemplary volatile read-write memories may include a random access memory (RAM). Exemplary RAMs may include a dynamic random access memory (DRAM), a double data rate synchronous dynamic random access memory (DDRSDRAM), a static random access memory (SRAM), a thyristor random access memory (T-RAM), a zero capacitance Random access memory (Z-RAM), etc. Exemplary read-only memories may include a mask-type read-only memory (MROM), a programmable read-only memory (PROM), an erasable programmable read-only memory (PEROM), an electrically erasable programmable read-only memory (EEPROM), a CD-ROM and digital versatile disk read-only memory, etc. In some embodiments, the storage device 150 may be implemented on a cloud platform. Merely by way of example, the cloud platform may include a private cloud, a public cloud, a hybrid cloud, a community cloud, a distributed cloud, an internal cloud, a multi-layer cloud, or the like, or any combination thereof. In some embodiments, the storage device 150 may be integrated on the server 110, the object 130, and/or the user terminal 140.

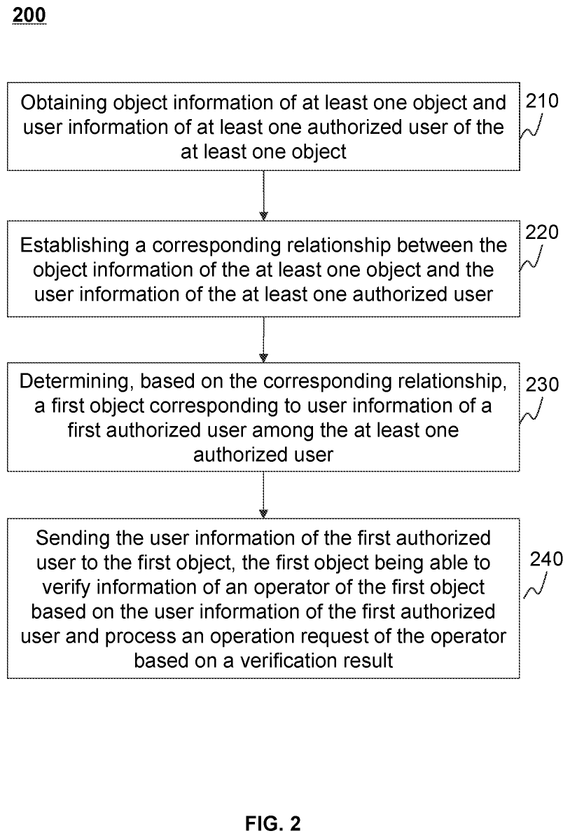

FIG. 2 is a schematic flowchart illustrating an exemplary process for information processing according to some embodiments of the present disclosure. In some embodiments, the process 200 may be executed by the server 110. The process 200 includes the following operations.

In 210, the processing device 112 may obtain object information of at least one object and user information of at least one authorized user of the at least one object. As used herein, an authorized user of an object refers to a user who is permitted or authorized to use the object by an administrator of the object. As mentioned above, the systems and methods of the present closure may be applicable to various objects including movable properties and real properties. For example, real property may include a room, etc., and movable property may include a vehicle, a locker, an electrical appliance, etc. The object may be equipped with a control device, such as a lock, a speed control device, an electrical switch, etc., to control the object based on an operation request of a user (e.g., an operator of the object, the at least one authorized user, etc.). In some embodiments, the object may include a room that includes a door lock. According to systems and methods of the present disclosure, the at least one authorized user may use the room, while excluding other people who have no permission from using the room. For example, the room may include a public rental housing that a tenant is permitted to use, or a hotel room that a hotel guest is allocated to. The authorized tenant or hotel guest may have the permission or authority to use the room that is permitted or allocated to them, and other people may be not available for the room, which may be effective to avoid a risk of subletting or transferring the room. In some embodiments, the object may include an electrical appliance. According to systems and methods of the present disclosure, the authorized user may use the electrical appliance, and other personnel may have no permission or authority to use the electrical appliance. For example, the electrical appliance in an institution may be authorized to a specific user within the institution for use, and others may be unable to operate the electrical appliance, thereby avoiding management burdens and/or safety hazards caused by unauthorized users. In some embodiments, when different authorized users are set to different levels of permission, operations that each authorized user has the permission to perform on the object may be different. For example, if the object is an air conditioner, an authorized user with a low level of permission may switch the air conditioner and may be unable to perform other operations such as temperature adjustment, and an authorized user with a high level of permission may perform other operations such as switching, adjusting temperature, adjusting the wind speed of the air conditioner, etc.

In some embodiments, the object information of the at least one object may include an object name, identification information, a model, a current state, historical usage information, etc. Taking a room as an example, the object (i.e., room) information may include identification information of the room. The identification information of the room may include an identification that is used to identify or distinguish the room from other rooms. A room identification may correspond to a room or residence, which may be a feature value corresponding to the room, such as a room number, a room address number, etc. Different rooms may correspond to different identifications. For example, when the identification information of the room includes a room number, the room number may include a room number of a public rental housing, such as 01, 02, 03, etc. The model of the object may indicate a type of the object (e.g., a room, a vehicle, an electric appliance, etc.). The model may indicate an initial performance or functions of the object. The current state may indicate the current performance or functions of the object. For example, the current state of a vehicle may include a mileage of the vehicle, an available energy (e.g., oil or power), the practical serviced life, etc. The historical usage information may include historical user information, historical usage records of the object, etc. The processing device 112 may generate recommendation information based on the historical usage information associated with the at least one object.

The user information of the authorized user may include identity verification information of the authorized user. The identity verification information of the authorized user may be used to verify whether the identity information of the authorized user has a permission of the object. The identity verification information may include exclusive characteristic information of the authorized user, such as biometric information, digital password information, etc. Therefore, it may be guaranteed that the corresponding authorized user may be able to use the specific object. The biometric information may include biometric characteristics of the object such as an inherent physiological characteristic or a behavioral characteristic of the user. For example, the physiological characteristic may include fingerprint information, iris information, palm vein information, face information, voice information, etc., and the behavioral characteristic may include gait characteristics, keystroke habits, etc. The digital password information may include a password including one or more digits, one or more letters, one or more characters, or the like, or a combination thereof.

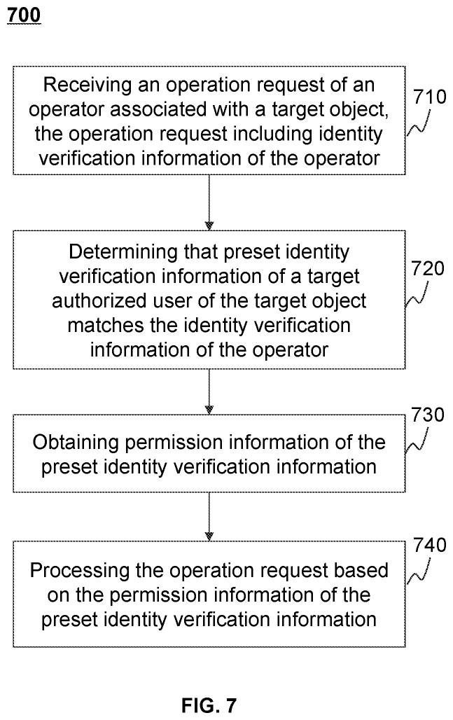

In some embodiments, the user information of the authorized user may also include permission information that is used to define a usage permission of the authorized user. For example, the permission information of the authorized user may define a function (i.e., a permission range), a service time range, a state, or the like, or any combination thereof, of the identity verification information of the authorized user. For instance, the function of the identity verification information may be used to indicate which operations of the authorized user are able or permitted to perform on the object the identity verification information corresponds to. For example, in the case of renting a house, the identity verification information of the authorized user may be used to indicate that the authorized user of the housing or the housing may perform at least one of unlocking and providing an alarm. The service time range of the identity verification information may be used to indicate a start time and an end time of the authorized user being able to use the object corresponding to the identity verification information. The state of the identity verification information may be used to indicate whether the identity verification information (e.g., preset biometric information) is available. For example, if the state of the identity verification information is an enabled state, the identity verification information may be available. If the state of the identity verification information is a disabled state, the identity verification information may be unavailable. More descriptions regarding the permission information may be found in FIG. 7 and the descriptions thereof, which will not be repeated herein.

Taking a public rental housing as an example, the identity verification information may be acquired and registered at two times. The first time may be when an application material is submitted by a user (e.g., the authorized user) for applying the public rental housing. After identity information of a tenant is checked and registered, the identity verification information of the tenant may be acquired, such as using a fingerprint acquisition device to acquire fingerprint information of the tenant. The second time may be when signing a contract after an inspection of the public rental housing is confirmed. After checking and confirming the identity information of the tenant, the fingerprint acquisition device may be used to acquire the fingerprint information of the tenant. In some embodiments, an acquisition process of the fingerprint information of the tenant may include receiving information of at least one fingerprint from the fingerprint acquisition device. For example, the fingerprint acquisition device may communicate with the server 110, and the server 110 may directly acquire the fingerprint information from the fingerprint acquisition device. Alternatively, the acquisition process of the fingerprint information of the tenant may include obtaining information of at least one fingerprint from a first intermediate device and the information of the at least one fingerprint on the first intermediate device may be obtained from the fingerprint acquisition device. The first intermediate device may include a gateway or a mobile terminal. If the first intermediate device includes a gateway, a communication manner between the fingerprint acquisition device and the gateway may be a wireless communication. The wireless communication may include a wireless fidelity Wifi communication, a Zigbee protocol, a Bluetooth communication, a 433 communication, etc. The server 110 may obtain the fingerprint information from the fingerprint acquisition device through the gateway. That is, the fingerprint acquisition device may first send the fingerprint information to the gateway, and the gateway may send the fingerprint information to the server 110. If the first intermediate device includes a mobile terminal, such as a mobile phone, the fingerprint acquisition device may be connected to the mobile phone via a Bluetooth communication, and the fingerprint information may be uploaded to the server 110 via the mobile phone.

In some embodiments, the object information of the object and/or the user information of the authorized user may be generated by a registration of the administrator of the object, and the authorized user may have no permission to register the information without authorization. For example, the administrator may input the object information and/or the user information via the user terminal 140 (e.g., a computer, a mobile phone, etc.), and upload the inputted information to the server 110. The administrator, such as a public rental housing management center, a talent apartment management center, etc., may be responsible for the management of objects. In some embodiments, the administrator may also update (including adding, modifying, deleting, invalidating, etc.) the input object information and/or user information. For example, when the administrator purchases or obtains new objects, or discards existing objects, the object information of the new objects may be added or the object information of the discarded object may be deleted. When a new user is authorized for an object or an authorized user loses the authorization (e.g., expiration of a service time range, cancellation of the authorization due to violation of regulations, etc.) of the object, the user information of the new user may be added, or the user information of the authorized user deleted or invalidated.

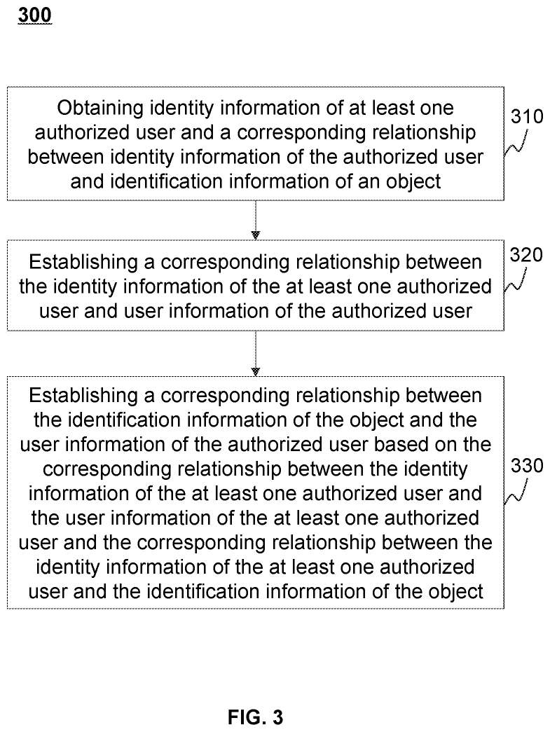

In 220, the processing device 112 may establish a corresponding relationship between the object information of the at least one object and the user information of the at least one authorized user. As used herein, the corresponding relationship between the object information of the at least one object and the user information of the at least one authorized user may also be referred to as a blinding relationship or mapping relationship between each of the at least one object and one of the at last one authorized user. Each of the at least one object may correspond to one of the at least one authorized user. Each of the at least one authorized user may include identity information (e.g., ID number). The identity information of the authorized user may correspond to the identification information of the at least object. In some embodiments, there may be a corresponding relationship between the identity information of the authorized user and the identification information (e.g., the number of a room). A corresponding relationship between the identity information of the authorized user and the user information of the authorized user may be established, and then a corresponding relationship between the identification information of the object and the user information of the authorized user may be established based on the corresponding relationship between the identity information of the authorized user and the user information of the authorized user and the corresponding relationship between the identity information of the authorized user and the identification information of the object. More descriptions regarding establishing the corresponding relationship between the object information and the user information of the authorized user may be found in FIG. 3 and the descriptions thereof.

In 230, the processing device 112 may determine, based on the corresponding relationship, a first object (also referred to as a target object) corresponding to user information of a first authorized user (also referred to as a target authorized user) among the at least one authorized user. For example, the corresponding relationship may be stored in a form of a mapping relationship table, and the server 110 may query the user information of the first authorized user in the mapping relationship table, and determine the corresponding first object. At the same time, the server 110 may obtain the object information of the first object.

In 240, the processing device 112 may send the user information of the first authorized user to the first object, the first object being able to verify information of an operator (also referred to as operator information) of the first object based on the user information of the first authorized user and process an operation request of the operator based on a verification result. The server 110 may send the user information of the authorized user (e.g., the first authorized user) to the corresponding object (e.g., the first object) corresponding to the identification information of the object directly or through a second intermediate device based on the corresponding relationship between the identification information of the object and the user information of the authorized user. Therefore, after the operator inputs the information (e.g., a fingerprint) of the operator via an information acquisition device (e.g., the fingerprint acquisition device) associated with the first object and the information of the operator is verified based on the user information of the authorized user, the object may process the operation request of the operator. After the first object receives the user information of the first authorized user, the first authorized user may perform operations on the first object, but other operators may not perform operations on the first object. In other words, an operator whose information (e.g., the identity verification information, the permission information) matches the user information of the first authorized user (e.g., the identity verification information) may be able or permitted to use the first object, i.e., the operator may be considered as the first authorized user. For example, when the operator requests an operation on the first object, the first object may verify the information of the operator based on the user information of the first authorized user. If the verification is passed or succeeds, the verification result may indicate that the operator has the operation permission and the requested operation may be performed. If the verification fails, the verification result may indicate that the operator does not have the operation permission and the requested operation may be refused by the first object to perform. In some embodiments, the first object (e.g., a processing device) may verify the information of the operator by determining whether identity verification information of the operator matches the identity verification information of the first authorized user, for example, whether a fingerprint of the operator matches a registered fingerprint of the first authorized user. If the identity verification information of the operator matches the identity verification information of the first authorized user, the verification may be passed (i.e., the operator may be considered as the first authorized user) and the first object may perform the operation requested by the operation request.

In some embodiments, after verifying that the operator is the first authorized user through the identity verification information, the first object may verify information associated with the operation (also referred to as operation information) based on the permission information of the first authorized user. For example, the first object may determine whether the operation requested by the operation request is within the permission range of the permission information of the first authorized user. If the operation requested by the operation request is within the permission range of the permission information of the first authorized user, the operation requested by the operation request may be executed after verification.

In some embodiments, if the information of the operator fails the verification, the first object may determine whether a count of times the operation request of the operator is consecutively received exceeds a count threshold (e.g., 5 times, 4 times, 3 times, etc.). If the count of times does not exceed the set count threshold, the first object may continue to receive the operation request of the operator and the information of the operator, and verify the information of the operator. If the count of times exceeds the count threshold, the first object may generate operation failure information and stop responding to the operation request of the operator. For example, the operation request may be refused. As another example, a next operation request may not be verified. Herein, “consecutively” means that there are no other operations between the two times that an operation request of the operator is received, and a time interval between the two times that the operation request of the operator is received may not be greater than a threshold (e.g., 1 minute, 40 seconds, 30 seconds, 20 seconds, 10 seconds, 5 seconds, etc.). In some embodiments, if the count of times the operation request of the operator is consecutively received exceeds the count threshold, alarm information may be generated by the first object. For example, if the first object includes a room that including a door lock, the door lock of the room or the room may emit an alarm sound, or the administrator (e.g., a management center of public rental housing, a hotel management center, etc.) may receive the alarm information to take security measures in time. Similarly, the server 110 may send user information of other authorized users to the corresponding objects, such as sending user information of a second authorized user to a second object, sending user information of a third authorized user to a third object, etc. Therefore, the objects may verify the information of the operator based on the received user information of the authorized users, and process the operation request of operators based on a verification result.

Similar to the manner that the server 110 obtains the user information of the authorized user in operation 210, the server 110 may have a plurality of manners to deliver the user information to the object. A first manner for delivering the user information to the object may be a direct communication. The server 110 may directly communicate with the object, and the server 110 may directly deliver the user information to the object (e.g., the door lock of the room). A second manner for delivering the user information to the object may be an indirect way through the second intermediate device. The second intermediate device may be a gateway or a mobile terminal, such as a mobile phone. For example, the user information may be delivered to the corresponding object through a networked gateway. A communication mode between the gateway and the object (e.g., the door lock controller) may be a wireless connection, and a wireless protocol may include a Wifi protocol, a Zigbee protocol, a Bluetooth protocol, a 433 protocol, etc. As another example, the user information may be delivered to the corresponding object through a mobile terminal. A software (e.g., an APP) on the mobile terminal may be logged in to connect to the corresponding object (e.g., via a Bluetooth manner, an infrared manner, etc.). The server 110 may send the user information to the mobile terminal, such as a mobile phone, and then the mobile terminal may deliver the corresponding user information to the corresponding object. In the embodiment, there are many manners for the server 110 to deliver the user information, thereby using different manners to deliver the user information in different usage scenarios.

It should be noted that in a process of delivering the user information, the user information may be encrypted. At this time, after the object receives the user information of the user, a decryption operation may be performed to obtain original data. In addition, the user information may also be sent directly without encryption.

The operation request of the operator may request the object to perform various operations. The functions or operations of the operation request may not be limited. For example, the operation request may be used to control a certain component to perform a certain action. Taking the first object as a room as an example, the operation request may be used to request a motor controlling the door lock to perform an unlocking action. Alternatively, the operation request may be used to request content modification, such as updating (e.g., modifying, adding, deleting, etc.) a digital password or a biometric password of the door lock, etc. In actual applications, the authorized user may preset a function of the operation request based on the application scenario of the method for processing the identity verification information according to some embodiments.

Accordingly, the server 110 may send the user information of the authorized user to the object corresponding to the corresponding identification information of the object. Therefore, after the object verifies the information of the operator based on the user information of the authorized user, the object may perform the operation requested by the operation request to ensure consistency of the operator and the authorized user. In addition, through the embodiments, remote verification and supervision of consistency of the operator and the authorized user with higher real-time and better effects may be realized.

It should be noted that although it is described above that the server sends the user information of the authorized user to the corresponding object and the object performs the operation verification, in some embodiments, the operation verification may also be completed by the server 110. In the case, the server 110 may no need to deliver the user information of the authorized user to the corresponding object. For example, after the object acquires the information of the operator, the information of the operator may be uploaded to the server 110. The server 110 may verify the uploaded information of the operator based on the user information of the authorized user corresponding to the object determined based on the corresponding relationship between the object information of at least one object and the user information of the at least authorized user, deliver a corresponding control instruction to the object based on a verification result, and control the object to execute or refuse the operation requested by the operator.

It should be noted that the above description of the process 200 is merely provided for the purposes of illustration, and not intended to limit the scope of the present disclosure. For persons having ordinary skills in the art, multiple variations and modifications on the process 200 may be made under the teachings of the present disclosure. However, those variations and modifications do not depart from the scope of the present disclosure.

FIG. 3 is a schematic flowchart illustrating an exemplary process for establishing a corresponding relationship between identification information of an object and user information of an authorized user according to some embodiments of the present disclosure. In some embodiments, the process 300 may be executed by the server 110. The process 300 includes the following operations.

In 310, the processing device 112 may obtain identity information of at least one authorized user and a corresponding relationship between the identity information of the authorized user and identification information of an object. For instance, the identity information of the authorized user may include information such as user name, ID number, mobile phone number, etc. For example, after a user applies for a room (e.g., a public rental housing) and the application for the room is passed or succeeds, identification information of the room that the user applies may be determined and the user may be considered as the authorized user. That is, there may be a corresponding relationship between the identification information of the authorized user and the identification information of the room.

In 320, the processing device 112 may establish a corresponding relationship between the identity information of the at least one authorized user and user information of the authorized user. The user information of the authorized user may include identity verification information, permission information, etc., as described elsewhere in the present disclosure (e.g., FIG. 2 and the descriptions thereof). For example, the processing device 112 may obtain the identity verification information of the authorized user via an information acquisition device (e.g., an input device, a fingerprint acquisition device, iris acquisition device, etc.), and upload the identity verification information to a location corresponding to the identity information of the authorized user, such as an acquisition box of the identity verification information. Therefore, the corresponding relationship between the identity information of at least one authorized user and the user information of the at least one authorized user may be established.

In 330, the processing device 112 may establish a corresponding relationship between the identification information of the object and the user information of the authorized user based on the corresponding relationship between the identity information of the at least one authorized user and the user information of the at least one authorized user and the corresponding relationship between the identity information of the at least one authorized user and the identification information of the object. For example, the identity information of the at least one authorized user may have the corresponding relationship with the identification information of the object, and the identity information of the at least one authorized user may also have the corresponding relationship with the user information of the at least one authorized user. Therefore, the corresponding relationship between the identification information of the object and the user information of the authorized user may be established through the identity information of the at least one authorized user.

It should be noted that the user information of one single authorized user may correspond to identification information of two or more objects. For example, one person may rent two rooms. In some embodiments, the identification information of one single object may correspond to the user information of two or more authorized users. For example, two or more persons may rent one single room. However, in general, the user information of one single authorized user may correspond to the identification information of one single object.

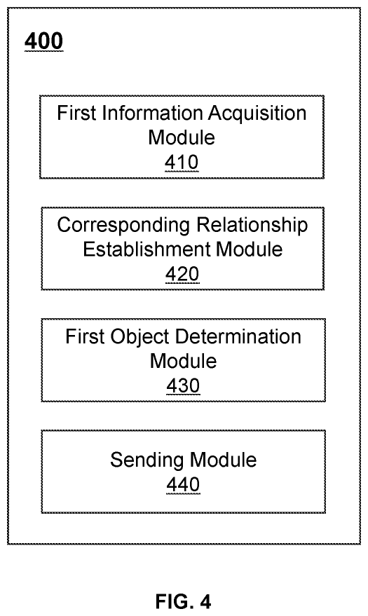

FIG. 4 is a block diagram illustrating an information processing system according to some embodiments of the present disclosure. The information processing system 400 (e.g., the processing device 112) may include a first information acquisition module 410, a corresponding relationship establishment module 420, a first object determination module 430, and a sending module 440. In some embodiments, the system 400 may be implemented on the server 110.

The first information acquisition module 410 may be configured to obtain information. In some embodiments, the first information acquisition module 410 may obtain object information of at least one object and user information of at least one authorized user of the at least one object. As used herein, an authorized user of an object refers to a user who is permitted or authorized to use the object by an administrator of the object. The object information of the at least one object may include an object name, identification information, a model, a current state, historical usage information, etc. The user information of the authorized user may include identity verification information of the authorized user. The identity verification information may be exclusive characteristic information of the authorized user, such as biometric information, digital password information, etc. In some embodiments, the identity verification information may be acquired by an acquisition device. For example, fingerprint information of the authorized user may be acquired by a fingerprint acquisition device, and the first information acquisition module 410 then may obtain the acquired identity verification information from the acquisition device. In some embodiments, the user information of the authorized user may also include permission information that is used to define a usage permission of the authorized user. For example, the permission information of the authorized user may define a function (i.e., a permission range), a service time range, a state, or the like, or any combination thereof, of the identity verification information of the authorized user.

The corresponding relationship establishment module 420 may be configured to establish a corresponding relationship between the object information of the at least one object and the user information of the at least one authorized user. As used herein, the corresponding relationship between the object information of the at least one object and the user information of the at least one authorized user may also be referred to as a blinding relationship or mapping relationship between each of the at least one object and one of the at last one authorized user. Each of the at least one object may correspond to one of the at least one authorized user. Each of the at least one authorized user may include identity information (e.g., ID number). The identity information of the authorized user may correspond to the identification information of the at least object. In some embodiments, there may be a corresponding relationship between the identity information of the authorized user and the identification information (e.g., the number of an object). A corresponding relationship between the identity information of the authorized user and the user information of the authorized user may be established, and then a corresponding relationship between the identification information of the object and the user information of the authorized user may be established based on the corresponding relationship between the identity information of the authorized user and the user information of the authorized user and the corresponding relationship between the identity information of the authorized user and the identification information of the object.

The first object determination module 430 may be configured to determine the object corresponding to the user information of the authorized user. For example, the first object corresponding to the first authorized user may be determined based on the user information of the first authorized user. For instance, the first object determination module 430 may determine the first object corresponding to the user information of the first authorized user based on the corresponding relationship established by the corresponding relationship establishment module 420.

The sending module 440 may be configured to send information. In some embodiments, the sending module 440 may send the user information of the authorized user to the corresponding object. After the object receives the user information of the corresponding authorized user, the object (e.g., a processing device) may verify the information of the operator accordingly, and process the operation request of the operator based on a verification result. The sending module 440 may send the user information of the authorized user (e.g., the first authorized user) to the object (e.g., the first object) corresponding to the identification information of the object directly or through a second intermediate device based on the corresponding relationship between the identification information of the object and the user information of the authorized user. Alternatively, a software (e.g., an APP) on the mobile terminal may be logged in to connect to the corresponding object. The sending module 440 may send the user information to the mobile terminal, such as a mobile phone, and then the mobile terminal may deliver the corresponding user information to the corresponding object. Therefore, after verifying the information of the operator based on the user information of the authorized user, the object may process the operation request of the operator.

It should be understood that the information processing system and the modules thereof shown in FIG. 4 may be implemented in various manners. For example, in some embodiments, the system and the modules thereof may be implemented by hardware, software, or a combination of software and hardware. As used herein, the hardware part may be realized by dedicated logic. The software part may be stored in a storage and executed by an appropriate instruction to execute systems, such as a microprocessor or dedicated design hardware. Those skilled in the art may understand that the above methods and systems may be implemented using computer-executable instructions and/or included in processor control codes. For example, the codes may be provided on such as a carrier medium (e.g., a disk, a CD, or a DVD-ROM), a programmable memory of a read-only memory (firmware), or a data carrier (e.g., an optical or electronic signal carrier). The system and the modules thereof of the present disclosure may be implemented by hardware circuits such as very large-scale integrated circuits or gate arrays, semiconductors (e.g., logic chips, transistors, etc.), programmable hardware devices (e.g., field-programmable gate arrays, programmable logic devices, etc.), various types of processors, or the like, or any combination thereof.

It should be noted that the above description of the information processing system 400 and the modules thereof are merely provided for the purposes of illustration, and not intended to limit the scope of the present disclosure. It should be understood that for persons having ordinary skills in the art, after understanding the principle of the system, it may be possible to arbitrarily combine various modules, or form subsystems to connect with other modules without departing from the principle. For example, in some embodiments, the first information acquisition module 410, the corresponding relationship establishment module 420, the first object determination module 430, and the sending module 440 disclosed in FIG. 4 may be different modules in a system, or may be one module that may realize the functions of the two or more modules mentioned above. Each module in the information processing system 400 may share a storage module. Alternatively, each module may also have its own storage module. Those variations do not depart from the scope of the present disclosure.

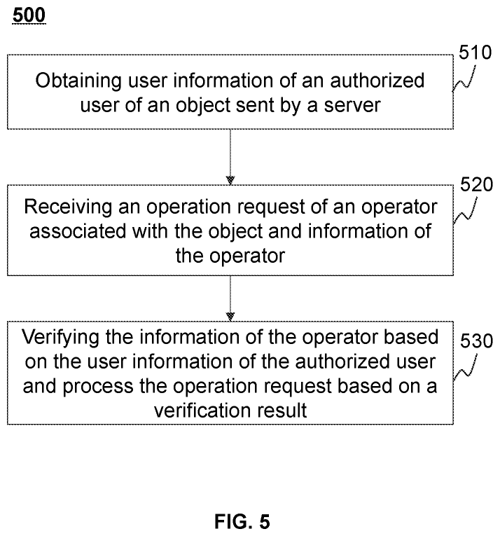

FIG. 5 is a schematic flowchart illustrating an exemplary process for information processing according to some embodiments of the present disclosure. In some embodiments, the process 500 may be executed by the object 130. The process 500 may include the following operations. In some embodiments, the object 130 may include a computing device. The computing device may include a processing device and a storage device including a set of instructions. The process 500 may be implemented on the computing device. For example, when executing the set of instructions, the processing device may be caused to perform the process 500.

In 510, the processing device (e.g., the second information obtaining module 610) may obtain user information of an authorized user (also referred to as a target authorized user) of an object (also referred to as a target object) sent by a server. In some embodiments, the object 130 may be authorized to a specific user for use, i.e., the target authorized user, and an authorization registration may be completed by the server 110. The server 110 may obtain registration information in the authorization registration. The registration information may include object information of the object 130 and the user information of the authorized user. The server 110 may establish a corresponding relationship between the object 130 (i.e., the object information) and the authorized user (i.e., the user information) as described in FIG. 3. In other words, the service 110 may bind the object 130 and the authorized user of the object 130 together. The server 110 may determine the user information of the authorized user of the object 130 based on the object information of the object 130 and the corresponding relationship between the object information of one or more objects and the user information of one or more authorized users of the one or more objects. Subsequently, the server 110 may send the user information of the authorized user to the corresponding object (e.g., the object 130). The user information of the authorized user may include identity verification information, such as biometric information and/or digital password information. The user information may also include permission information that is configured to define a permission range, a service time range, or a permission state of the authorized user for using the object. The processing device may obtain the user information of the authorized user directly sent by the server 110. Alternatively, the processing device may obtain the user information from a second intermediate device transmitted by the server 110.

In 520, the processing device (e.g., the second operation receiving module 620) may receive an operation request of an operator associated with the object and information of the operator (also referred to as operator information). In the embodiment, a function of the operation request may be various according to different application scenarios. For example, the operation request may be used to control a certain component of the object 130 to perform a certain action. Taking the object 130 being a room as an example, the operation request may be used to request to control a motor of a door lock of the room to perform an unlocking action. Alternatively, the operation request may be used to request content updating (e.g., modification, deletion, addition, etc.), such as modifying a digital password or a biometric password of the door lock, etc. In actual applications, the user may pre-set the operation request according to the application scenarios of the methods for processing the identity verification information provided by the present disclosure. The information of the operator may include identity verification information of the operator, such as biometric information.

In some embodiments, the object 130 may be configured with information acquisition device (e.g., an input device, a fingerprint acquisition device, an iris acquisition device (e.g., a camera). The processing device may obtain the operation request of the operator and/or information of the operator via the information acquisition device. In some embodiments, the processing device may obtain the operation request of the operator and/or information of the operator via a third intermediate device. The third intermediate device may include a mobile device that is configured with a user interface for facilitating a communication between the processing device and the operator. The user interface may be implemented as a software (e.g., an APP) on the mobile terminal. The operator may be logged in the user interface and the mobile terminal may be connected to the corresponding object (e.g., via a Bluetooth manner, an infrared manner, etc.).

It should be noted that, in some embodiments, the operation request may be automatically generated in response to receiving the operator information from the operator. For example, taking an operator attempting to open a door lock of a room by swiping a fingerprint as an example, in response to the fingerprint swiping operation of the operator, a fingerprint acquisition device associated with the door lock may automatically generate an unlock request while acquiring the identity verification information of the operator. In other words, in some embodiments, the two operations of receiving the operation request and receiving the information of the operator may be performed simultaneously or combined. For instance, taking an operator attempting to open a door lock of a room by swiping a fingerprint as an example, in response to the swiping fingerprint operation of the operator, the fingerprint acquisition device may consider that the unlock request is received while acquiring the identity verification information of the operator. In some embodiments, after the identity verification information of the operator is acquired, the acquired identity verification information, such as the fingerprint information, may be detected in vivo to avoid fingerprint fraud.

In 530, the processing device (e.g., the second operation verification module 630) may verify the information of the operator based on the user information of the authorized user and process the operation request based on a verification result. In some embodiments, the object 130 may verify whether the identity verification information of the operator matches the identity verification information of the authorized user. If the identity verification information of the operator matches the identity verification information of the authorized user, the object may execute an operation requested by the operation request. If the identity verification information of the operator does not match the identity verification information of the authorized user, the object may refuse to execute the operation. In some embodiments, after verifying that the identity verification information of the operator matches the identity verification information of the authorized user, the permission information of the authorized user may be further verified. If the authorized user has the permission of the operation requested by the operation request, the object may perform the operation. The permission information may be configured to define a function (i.e., the permission range) of the identity verification information, a service time range of the identity verification information, a state of the identity verification information, or the like, or any combination thereof. The permission range of the identity verification information may include operations being performed on the object that the authorized user is permitted. In some embodiments, when the permission information satisfies one or more of the following conditions, it may mean that the authorized user has the corresponding permission, and the object may perform the operation requested by the operation request. The one or more conditions may include that a receiving time of the operation request is within the service time range of the identity verification information of the authorized user, the state of the identity verification information of the authorized user is an enabled state, the function of the identity verification information of the authorized user includes a function corresponding to an operation requested by the operation request, or a combination thereof.

In some embodiments, if the information of the operator does not pass the verification, the processing device may determine whether a count of times the operation request of the operator is consecutively received exceeds a count threshold (e.g., 5 times, 4 times, 3 times, etc.). If the count of times does not exceed the count threshold, the object 130 may continue to receive the operation request of the operator and the information of the operator, and verify the information of the operator based on the user information of the authorized user. If the count of times exceeds the count threshold, the processing device may generate operation failure information and stop responding to the operation request of the operator. In some embodiments, if the count of times the operation request of the operator is consecutively received exceeds the count threshold, alarm information may also be generated. For example, the door lock of the room may emit an alarm sound, or an administrator of the object may receive the alarm information to take safety measures in time.

It should be noted that the above description of the process 500 is merely provided for the purposes of illustration, and not intended to limit the scope of the present disclosure. For persons having ordinary skills in the art, multiple variations and modifications on the process 500 may be made under the teachings of the present disclosure. However, those variations and modifications do not depart from the scope of the present disclosure.

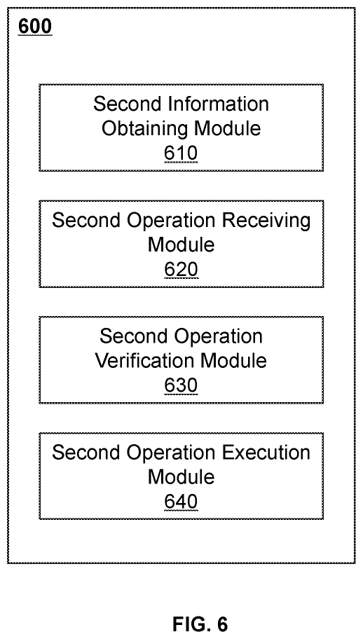

FIG. 6 is a block diagram illustrating an information processing system according to some embodiments of the present disclosure. The system 600 may include a second information obtaining module 610, a second operation receiving module 620, a second operation verification module 630, and a second operation execution module 640. In some embodiments, the system 600 may be implemented on the object 130.

The second information obtaining module 610 may be configured to obtain information. For example, user information of an authorized user sent by a server may be obtained. The user information of the authorized user may include identity verification information, such as biometric information, digital password information, etc. The user information may also include permission information that is configured to define a usage permission of the authorized user. The second information obtaining module 610 may obtain the user information of the authorized user directly sent by the server 110. Alternatively, the second information obtaining module 610 may obtain the user information from a second intermediate device transmitted by the server 110.

The second operation receiving module 620 may be configured to receive information. For example, an operation request of an operator of the object and information of the operator (also referred to as operator information) may be received. The information of the operator may include identity verification information of the operator, such as biometric information, digital password information, etc. In some embodiments, the operation request may be generated in response to receiving information from the operator. For example, taking an operator attempting to open a door lock of a room by swiping a fingerprint as an example, in response to the fingerprint swiping operation of the operator, a fingerprint acquisition device associated with the door lock may automatically generate an unlock request while acquiring the identity verification information of the operator.

The second operation verification module 630 may be configured to verify the information of the operator. In some embodiments, the second operation verification module 630 may verify whether the identity verification information of the operator matches the identity verification information of the authorized user. If the identity verification information of the operator matches the identity verification information of the authorized user, the verification may be passed or succeed. In some embodiments, after verifying that the identity verification information of the operator matches the identity verification information of the authorized user, the second operation verification module 630 may further verify the permission information of the authorized user. If the authorized user has the permission of the operation requested by the operation request, the verification may be passed or succeed.

The second operation execution module 640 may be configured to execute an operation requested by the operation request. For example, if the verification that the second operation verification module 630 verifies the information of the operator is passed or succeeds, the second operation execution module 640 may execute the operation requested by the operation request. If the verification fails, the second operation execution module 640 may refuse to execute the operation requested by the operation request. In some embodiments, if the information of the operator does not pass the verification, the second operation execution module 640 may determine whether a count of times the operation request of the operator is consecutively received exceeds a count threshold (e.g., 5 times, 4 times, 3 times, etc.). If the count of times does not exceed the count threshold, the second operation execution module 640 may continue to receive the operation request of the operator and the information of the operator, and verify the information of the operator based on the user information of the authorized user. If the count of times exceeds the count threshold, the second operation execution module 640 may generate operation failure information and stop responding to the operation request of the operator. In some embodiments, if the count of times the operation request of the operator is consecutively received exceeds the count threshold, the second operation execution module 640 may also generate alarm information. For example, the door lock of the room may emit an alarm sound, or an administrator of the object may receive the alarm information to take safety measures in time.

It should be understood that the information processing system and the modules thereof shown in FIG. 6 may be implemented in various manners. For example, in some embodiments, the system and the modules thereof may be implemented by hardware, software, or a combination of software and hardware. As used herein, the hardware part may be realized by dedicated logic. The software part may be stored in a storage and executed by an appropriate instruction to execute systems, such as a microprocessor or dedicated design hardware. Those skilled in the art may understand that the above methods and systems may be implemented using computer-executable instructions and/or included in processor control codes. For example, the codes may be provided on such as a carrier medium (e.g., a disk, a CD, or a DVD-ROM), a programmable memory of a read-only memory (firmware), or a data carrier (e.g., an optical or electronic signal carrier). The system and the modules thereof of the present disclosure may be implemented by hardware circuits such as very large-scale integrated circuits or gate arrays, semiconductors (e.g., logic chips, transistors, etc.), programmable hardware devices (e.g., field-programmable gate arrays, programmable logic devices, etc.), various types of processors, or the like, or any combination thereof.

It should be noted that the above description of the information processing system 600 and the modules thereof are merely provided for the purposes of illustration, and not intended to limit the scope of the present disclosure. It should be understood that for persons having ordinary skills in the art, after understanding the principle of the system, it may be possible to arbitrarily combine various modules, or form subsystems to connect with other modules without departing from the principle. For example, in some embodiments, the second information acquisition module 610, the second operation receiving module 620, the second operation verification module 630, and the second operation execution module 640 disclosed in FIG. 6 may be different modules in a system, or may be one module that may realize the functions of the two or more modules mentioned above. Each module in the information processing system 600 may share a storage module. Alternatively, each module may also have its own storage module. Those variations do not depart from the scope of the present disclosure.

FIG. 7 is a schematic flowchart illustrating an exemplary process for information processing according to some embodiments of the present disclosure. In some embodiments, the process 700 may be executed by the server 110 and/or the object 130. For example, the object 130 may include a computing device that includes a storage device and a processing device. The storage device may store a set of instruction in a storage device. When executing the set of instructions, the processing device may be caused to perform the process 700. The process 700 may include the following operations.

In 710, the processing device may receive an operation request of an operator associated with an object (also referred to as a target object), the operation request including identity verification information of an operator. In some embodiments, the identity verification information of the operator may include biometric information of the operator (also referred to as biometric password) and/or digital password information. The biometric information of the operator may include one or more inherent physiological characteristics, one or more behavioral characteristics of the operator. As used herein, a physiological characteristic may include a fingerprint characteristic, an iris characteristic, a face characteristic, a voice characteristic, or the like, or any combination thereof. A behavioral characteristic may include gait characteristics, keystroke habits, or the like, or any combination thereof. The identity verification information of the operator may be input by the operator via an information acquisition device associated with the object 130. In some embodiments, the information acquisition device may include a fingerprint acquisition device (e.g., a fingerprint sensor), an iris acquisition device (e.g., an iris camera), a video camera, a voice recorder, a pressure sensor, or the like, or any combination thereof. In some embodiments, the information acquisition device may be integrated into the object 130. In some embodiments, the information acquisition device may be connected or in communication with the object 130 and/or the server 110. The identity verification information of the operator may be transmitted to the server 110 by the information acquisition device or the object 130. It should be understood that the operation request may be a request that may be executed after verifying the identity verification information of the operator.

In some embodiments, the operation request may include the identity verification information of the operator. For example, the generation of the operation request may be triggered by the acquisition of the identity verification information. The operation request may be bound to the information acquisition device for acquiring the identity verification information of the operator. Therefore, after the information acquisition device is triggered to acquire the identity verification information of the operator input by the operator, the operation request may be automatically bound to the identity verification information acquired by the information acquisition device, and the operation request including the identity verification information of the operator input by the operator may be sent to the server 110 or the object 130. In some embodiments, the bound of the identity verification information of the operator input by the operator and the operation request may refer to that the identity verification information of the operator input by the operator and the operation request may be separate pieces of information being bound, or the identity verification information of the operator input by the operator and the operation request may each be embedded in each other as sub-information. Taking an unlocking action of a motor controlling a door lock as an example, the door lock may be opened after the operator inputs a verification fingerprint, and the operation request may be included in the process of inputting the verification fingerprint. In other words, the input of the verification fingerprint may trigger the generation of the operation request and the operation request for unlocking action including the verification fingerprint may be transmitted to the processing device 112. In some embodiments, the operation request including the identity verification information of the operator may also be referred to as the identity verification information of the operator including the operation request.

In some embodiments, the operation request may be used to request an operation performed by one or more components (e.g., the object 130) of the information processing system 100. For example, the operation request may be used to control a certain component to perform a certain action, such as the motor used to control the door lock to perform an unlock action. Alternatively, the operation request may be used for content updates (e.g., modification, deletion, addition, etc.), such as modifying a password of the door lock, etc. In actual applications, the operator may pre-set the operation request according to the application scenario of the method for processing the identity verification information provided by the embodiment.

In 720, the processing device may determine that preset identity verification information of an authorized user (also referred to as target authorized user) of the object matches the identity verification information of the operator. In some embodiments, the preset identity verification information of the authorized user may be identity verification information of the authorized user input in advance. For example, the preset identity verification information may include identity verification information of a first user inputting N times. As used herein, the identity verification information of the first user may be input through at least one of the information acquisition devices as described elsewhere in the present disclosure. The identity verification information of the first user input each time may be a portion of information of the same user, and the identity verification information of the first user input each time may include at least a part of information different from those of other times to form the preset identity verification information of the first user (e.g., complete biometric information), wherein N is a natural number greater than 1.

In some embodiments, the preset identity verification information of multiple authorized users of multiple objects may be acquired and stored by the server 110 in a storage device (e.g., the storage device 150). Each of the multiple objects may correspond to one or more authorized users. The server 110 may obtain object information of the authorized objects. The server 110 may establish a corresponding relationship between the preset identity verification information of multiple authorized users and the object information of the multiple objects. The server 110 may obtain the object information of the target object and determine the preset identity verification information of the target authorized user corresponding to the target object based on the object information of the target object and the corresponding relationship. The server 110 may send the determined preset identity verification information of the target authorized user to the processing device of the object 130. The processing device of the object 130 may determining whether the preset identity verification information of the target authorized user matches the preset identity verification information of the operator. If the preset identity verification information of the user matches the preset identity verification information of the operator, the processing device 112 may consider that the identity information of the target user may be consistent with the identity information of the operator.

In some embodiments, after the server 110 determines the preset identity verification information of the target authorized user of the target object, permission information corresponding to the preset identity verification information of the target authorized user may be set or obtained. For example, the permission information corresponding to the preset identity verification information may have a corresponding relationship between the preset identity verification information. The server 110 may obtain the permission information based on the corresponding relationship between the permission information and the preset identity verification information and the determined preset identity verification information. The permission information corresponding to the preset identity verification information may be configured to define a function (e.g., a permission range) of the preset identity verification information, a service time range of the preset identity verification information, a state of the preset identity verification information, or the like, or any combination thereof. For instance, the function of the preset identity verification information may be configured to indicate which operations the user is able or permitted to perform on an object the preset identity verification information may correspond to. For example, the function of the preset identity verification information may include unlocking, alarming, or the like, or any combination thereof. The service time range of the preset identity verification information may be configured to indicate a start time and an end time of the preset identity verification information. The state of the preset identity verification information may be configured to indicate whether the preset identity verification information is available. For example, when the state of the preset identity verification information is an enabled state, it indicates that the preset identity verification information is available. If the state of the preset identity verification information is a disabled state, it indicates that the preset identity verification information is unavailable.

In some embodiments, the preset identity verification information may be controlled by defining the permission information corresponding to the preset identity verification information.

For example, the permission information corresponding to the preset identity verification information may be temporarily set as pending permission information.

Then, the server 110 may determine whether the pending permission information satisfies a preset requirement. For example, the server 110 may determine whether the service time range of the pending permission information is reasonable (e.g., whether the length of the service time range is longer than a preset threshold, whether a time period (e.g., late at night) of the service time range is restricted, etc.), determining whether the function of the pending permission information is reasonable (e.g., whether a permission level of the pending permission is higher than a preset level), or the like, or a combination thereof. If the pending permission information satisfies the preset requirement, the pending permission information may be determined as the permission information of the preset identity verification information. If the pending permission information does not satisfy the preset requirement, the pending permission information may not be determined as the permission information of the preset identity verification information.

In some embodiments, the preset identity verification information may be controlled by changing or updating (e.g., modifying, adding, deleting, etc.) the permission information corresponding to the preset identity verification information, such as by changing the function, the service time range, the state, or the like, or any combination thereof, of the preset identity verification information to control the preset identity verification information. For example, a control device (or the processing device) of the object 130 may use any media control manner (e.g., an application, a gateway, a host computer program, etc.) to send a modification instruction to modify the permission information. As a further example, the control device may send the modification instruction via a data transmission channel, such as a wireless network (Wifi), ZigBee, Bluetooth Low Energy (Bluetooth, or BLE), Narrow Band Internet of Things (NB-IoT), Near Field Communication (NFC), or other channels.

The following descriptions are provided regarding the function of preset identity verification information as unlocking. It should be noted that the descriptions of unlocking in the present disclosure are merely provided for illustration, and not intended to limit the scope of the present disclosure.

When the preset identity verification information is restricted to perform an operation (e.g., opening a room door lock) on the object (i.e., the preset identity verification information having no the function corresponding to the operation), the function (e.g., modifying the function to empty or other functions except unlocking) or the state (e.g., changing the state to a disabled state) of the preset identity verification information may be modified without deleting the preset identity verification information to achieve a purpose of restricting the preset identity verification information to perform the operation on the object.

When the preset identity verification information is re-allowed to perform an operation on the object, the function (e.g., modifying the function to unlocking) or the state (e.g., modifying the state to an enabled state) of the preset identity verification information may be modified without re-inputting the preset identity verification information to achieve the function of unlocking of the preset identity verification information.

When the service time range of the preset identity verification information needs to be shortened or extended, the service time range of the preset identity verification information may be updated without re-inputting the preset identity verification information to achieve a purpose of shortening or extending the service time range.

In some embodiments, the preset identity verification information and the permission information corresponding to the preset identity verification information may be stored in a form as shown in Table 1. Two IDs (e.g., ID corresponding to the preset identity verification information (e.g., identity identification number) and internal ID of a preset identity feature (i.e., identity verification information) library for storing the preset identity verification information) may be stored in a storage area of an algorithm chip corresponding to the information acquisition device, and the two IDs may be used as identification information of the preset identity verification information to find the corresponding preset identity verification information. The other four pieces of information may include the permission information corresponding to the preset identity verification information, which may be stored in the storage area corresponding to a device applying the method for processing the identity verification information provided in the present disclosure. Taking a door lock as an example, the permission information corresponding to the preset identity verification information may be stored in a storage area of a control chip of the door lock.

TABLE 1
A Storage Format of Preset Identity Verification
Information and Permission Information Corresponding
to Preset Identity verification Information

| | | | | | |
|---|---|---|---|---|---|
| ID corresponding to | Internal ID of | Start | End | State | Function |
| the preset identity | preset identity | time | time | | |
| verification | feature library | | | | |
| information | | | | | |

In some embodiments, before storing the preset identity verification information and the permission information corresponding to the preset identity verification information, the storing may be performed when the permission information corresponding to the preset identity verification information is verified. A purpose of the verification may be to verify a validity of the permission information corresponding to the preset identity verification information. Therefore, for the preset identity verification information, the validity of the permission information may need to be verified when the permission information is stored for the first time, and the validity of the permission information may not need to be verified when the permission information is updated (e.g., modified).

In some embodiments, after the permission information corresponding to the preset identity verification information is verified, a specific function may be added to or deleted from the function of the preset identity verification information. For example, the specific function may be used to indicate that a level of the preset identity verification information is higher than a level of other preset identity verification information, and indicate that the user corresponding to the preset identity verification information may manage the information stored locally by the device (e.g., the object) applying the method for processing the identity verification information provided in the present disclosure. The management of the information may include modifying service time of a door lock, modifying a password, other management (e.g., addition, deletion, modification, etc.) of the preset identity verification information, managing history log records of a terminal, etc.

In some embodiments, the identity verification information may include biometric information, and after the preset identity verification information is sent to the processing device of the object 130, the processing device of the object 130 may determine whether the preset identity verification information of the operator matches the identity verification information of the target authorized user based on biometric points in the biometric information of the operator and biometric points in each preset biometric information of each of the multiple users. For example, the processing device may compare biometric points in the biometric information of the operator with biometric points in the preset biometric information of the target authorized user, and determine a count of biometric points in the biometric information of the operator that is the same as the biometric points in the preset biometric information of the target authorized user. The preset identity verification information of the target authorized user may be determined based on the count of the same biometric points. For instance, if the count of the same biometric points in the biometric information of the operator and the preset biometric information of the target authorized user is within a preset count range, the preset identity verification information of the target authorized user may be regarded as the preset identity verification information with the identity verification information of the operator. In some embodiments, the preset count range may be determined based on actual applications, which is not limited in the present disclosure. A biometric point for different types of biometric information may be different. For example, for fingerprint information, the biometric point may include a starting point, an end point, a joining point, a bifurcation point, etc. in a fingerprint line. As another example, for iris information, the biometric point may include a spot, a filament, a crypt, etc., on radioactive stripes of an iris. As still another example, for facial information, the biometric point may include color, contour, distribution distances of sense organs, etc., of a human face. As further another example, for sound information, the biometric point may include a frequency of a sound wave of a voiceprint, an amplitude of vibration of the sound wave, a vibration waveform of the sound wave, a sound frequency spectrum structure, etc. In some embodiments, the processing device may determine whether the preset identity verification information matches the identity verification information of the operator by combining different types of biometric information (e.g., the fingerprint information, the iris information, etc.) for improving the accuracy of the determined preset identity verification information.

Alternatively, the biometric information may include behavioral characteristics, and the processing device may determine whether the preset identity verification information of the target authorized user matches the identity verification information of the operator based on behavioral feature points in the identity verification information of the operator and behavioral feature points in each preset identity verification information. For example, by comparing the behavioral feature points in behavioral characteristics of the operator with the behavioral feature points in the preset identity verification information of the target authorized user, a count of behavioral feature points in the behavioral characteristics of the operator that is the same as the behavioral feature points in the preset identity verification information of the target authorized user may be obtained. The preset identity verification information may be determined based on the count of the same behavioral feature points in the behavioral characteristics of the operator and the preset identity verification information. For instance, if the count of the same behavioral feature points is within a preset count range, the preset identity verification information of the target authorized user r may be regarded to match the identity verification information of the operator. In some embodiments, the preset count range may be determined based on actual applications, which is not limited in the present disclosure. In some embodiments, the behavioral feature points may be different for different types of behavioral characteristics. For example, for gait characteristics, the behavioral feature point may include a pedestrian contour, or the like. As another example, for keystroke habits, the behavioral feature point may include pressure information, keystroke time interval information, etc.

In some embodiments, the processing device 112 may determine a similarity between the identity verification information of the operator and the preset identity verification information of each of the multiple users. The processing device 112 may determine the preset identity verification information that matches the identity verification information of the operator based on similarities between the identity verification information of the operator and the preset identity verification information of the multiple users. For example, the processing device 112 may designate the preset identity verification information of one of the multiple users that has a maximum similarity as the preset identity verification information that matches the identity verification information of the operator.

In 730, the processing device may obtain the permission information of the preset identity verification information. As described in operation 720, when the preset identity verification information is determined, the permission information corresponding to the preset identity verification information may be set, and stored in the storage area of the algorithm chip corresponding to the information acquisition device in the form shown in Table 1. Therefore, the preset identity verification information and the permission information may have a corresponding relationship. Furthermore, after the preset identity verification information is determined, the permission information corresponding to the preset identity verification information may be obtained, based on the corresponding relationship, by retrieving the ID corresponding to the preset identity verification information (e.g., identity identification number) and/or the internal ID of the preset feature library in the storage area.

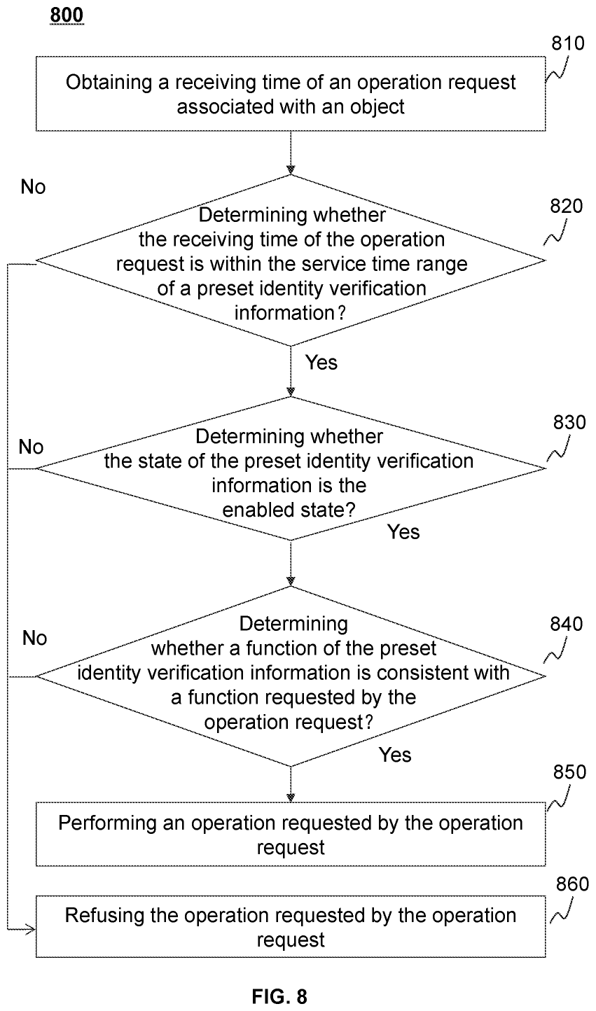

In 740, the processing device may process the operation request based on the permission information of the preset identity verification information. In some embodiments, the operation requested by the operation request may be performed in response to determining that one or more conditions are satisfied based on the permission information corresponding to the preset identity verification information. The one or more conditions may include that the time for receiving the operation request is within the service time range of the preset identity verification information, the function of the preset identity verification information includes the operation requested by the operation request, the state of the preset identity verification information is an enable state, or the like, or a combination thereof. If the one or more conditions are satisfied, the operation requested by the operation request may be performed. Otherwise, the operation requested by the operation request may not be executed. In some embodiments, when the one or more conditions are satisfied, all preset identity verification information of the multiple users may be obtained. For each of at least a portion of all the preset identity verification information, the processing device may determine whether a current time when the operation request is received is within the service time range of each of at least a portion of all the preset identity verification information. If the current time is not within the service time range of each of at least a portion of all the preset identity verification information, the state of each of at least a portion of all the preset identity verification information may be updated to be a disabled state, and the operation requested by the operation request may not be performed. In some embodiments, when the one or more conditions are satisfied, and the current time is within the service time range of each of at least a portion of all the preset identity verification information, the processing device may further determine whether a function of each of at least a portion of all the preset identity verification information includes the operation requested by the operation request. If the function of each of at least a portion of all the preset identity verification information does not include the operation requested by the operation request, the state of each of at least a portion of all the preset identity verification information may be updated to a disabled state, and the operation requested by the operation request may not be performed. If the function of each of at least a portion of all the preset identity verification information includes the operation requested by the operation request, the operation requested by the operation request may be executed. More descriptions regarding operation 740 may be found in FIG. 8 and the descriptions thereof.

In some embodiments, the operation request may include an update request for updating the preset identity verification information, and the processing device may update the preset identity verification information by updating the permission information. The update of the permission information corresponding to the preset identity verification information may be automatically triggered by the operator or the trigger via inputting the operation request. In some embodiments, the update of the permission information corresponding to the preset identity verification information may be automatically triggered after the preset identity verification information that matches the identity verification information of the operator is determined. For example, the update of the permission information corresponding to the preset identity verification information may be automatically triggered. Alternatively, the update of the permission information corresponding to at least a portion of all the preset identity verification information may be automatically triggered. The processing device may determine whether the permission information of the preset identity verification information satisfies one or more conditions; and in response to determining that the permission information of the preset identity verification information does not satisfy at least one of the one or more conditions, the processing device may update the permission information of the preset identity verification information.

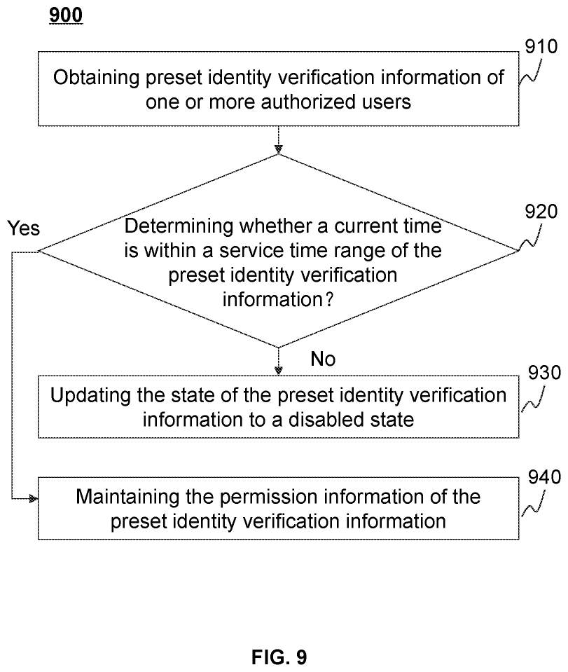

In some embodiments, the permission information may be updated by determining whether the service time range of the preset identity verification information includes the current time. If the service time range of the preset identity verification information does not include the current time, the state of the preset identity verification information may be modified to an invalid or disabled state to indicate that the preset identity verification information exceeds the service time range, and the preset identity verification information and the permission information corresponding to the preset identity verification information may be deleted, thereby saving storage space of the preset identity verification information and the permission information. More descriptions regarding the automatically updating the permission information may be found in FIG. 9 and the descriptions thereof.

In some embodiments, the permission information and/or the preset identity verification information may be updated by deleting at least a portion of the preset identity verification information and/or the permission information. For example, when the authorized user or the operator intends to updating the permission information (and/or the preset identity verification information), the authorized user or the object may input an update request via an information acquisition device (e.g., an input device, such as a mobile terminal) and the update instruction may be transmitted to the server 110 by the control device (e.g., the processing device in the object 130). The server 110 or the control device of the object 130 may perform an authentication operation in response to receiving the update request. The authentication operation refers to verifying whether the authorized user or the operator has a permission to update the permission information (and/or the preset identity verification information). In some embodiments, the authentication operation may include inputting identity verification information (e.g., biometric information) for authentication. The identity verification information may be included in the update request. That is, new identity verification information may be input. In response to determining that the authorized user or the operator has a permission to update the permission information (and/or the preset identity verification information), the processing device 120 may update the at least a portion of the permission information (and/or the preset identity verification information) based on the identity verification information (e.g., biometric information) for authentication or an input information associated the permission information. Therefore, the processing device 120 may delete the preset identity verification information and/or the permission information, and designate the biometric information for authentication and the permission information as new identity verification information of the user. In some embodiments, the processing device 120 or the object 130 may determine whether the authorized user or the operator has a permission to update the permission information (and/or the preset identity verification information) based on the permission information corresponding to the present identity verification information. For example, the permission information corresponding to the present identity verification information may define the function of the present identity verification information. If the function of the present identity verification information includes updating the present identity verification information or the permission information, the processing device 120 or the object 130 may determine that the authorized user or the operator has the permission to update the permission information (and/or the preset identity verification information).

In some embodiments, the permission information corresponding to the preset identity verification information may be updated through an external instruction. For example, an update request sent by a control device may be received, the preset identity verification information to be updated may be determined based on the biometric information included in the permission update request, and the permission information corresponding to the determined preset identity verification information may be updated based on updated content included in the update request.

The update request may be sent by a user with permission information management via the control device. The control device may send the update request through a data transmission channel. For example, the control device may send the permission update request through any one of ZigBee, BLE, NB-loT, NFC, etc. In addition, the update request may include identity verification information and the updated content. Therefore, the identity verification information included in the update request may indicate at least a portion of the preset identity verification information needs to be updated (i.e., the above preset identity verification information to be updated), and the permission information corresponding to the at least a portion of identity verification information may be updated using the content included in the updated content. For example, if the updated content includes a service time range, the service time range of the preset identity verification information may be updated to the service time range included in the updated content.

Regarding the manners of updating the permission information, if a device for processing the identity verification information provided includes a networked device, after the permission information is updated, the updated permission information may be sent to the server 110 through a communication module, and then the server 110 may send the updated permission information to a client used by the user. Therefore, the user may view the permission information corresponding to the preset identity verification information with help of the client. In addition, after the permission information is updated, when the identity verification information is identified a next time, the updated permission information may be used to control a response to the operation request.

It should be noted that the above description of the process 700 is merely provided for the purposes of illustration, and not intended to limit the scope of the present disclosure. For persons having ordinary skills in the art, multiple variations and modifications on the process 700 may be made under the teachings of the present disclosure. For example, operations 730 and 740 may be combined into one operation. However, those variations and modifications do not depart from the scope of the present disclosure.

FIG. 8 is a schematic flowchart illustrating an exemplary process for processing an operation request according to some embodiments of the present disclosure. In some embodiments, the process 800 may be implemented in the information processing system 100 shown in FIG. 1. For example, at least a portion of the process 800 may be stored in the storage device 150 in a form of instructions that may be retrieved and/or executed by the server 110. In some embodiments, a portion of the process 800 may be implemented on a terminal device. For example, the object 130 may include a computing device that includes a storage device and a processing device. The storage device may store a set of instruction in a storage device. When executing the set of instructions, the processing device may be caused to perform the process 800. Operation 740 may be performed according to process 800.

In 810, the processing device may obtain a receiving time of an operation request associated with an object. In some embodiments, before operation 810, the process 800 may further include obtaining preset identity verification information of an authorized user of the object by searching ID corresponding to the preset identity verification information (e.g., identity identification number) and/or an internal ID of a preset feature (e.g., identity verification information) library from a storage area as described in FIG. 7. The preset identity verification information of the authorized user of the object may include identity verification information of the authorized user of the object input in advance. The preset identity verification information may include permission information for indicating which operations a function of the preset identity verification information may correspond to, such as unlocking, alarming, etc. The permission information may be also used to indicate a start time and an end time of the preset identity verification information (i.e., the service time range). The permission information may be further used to indicate a state of the preset identity verification information, such as an enabled state and a disabled state. Therefore, the operation request may be processed based on the permission information corresponding to the preset identity verification information. Accordingly, for any preset identity verification information, it may be possible to control whether to respond to the operation request by modifying the permission information corresponding to the preset identity verification information, thereby not repeatedly inputting the preset identity verification information, and reducing difficulty of managing the identity feature information.

In 820, the processing device may determine whether the receiving time of the operation request is within the service time range of the preset identity verification information. The processing device may determine whether a current time (i.e., the receiving time) is within the service time range of each of at least a portion of the preset identity verification information. In response to that the current time is within each of at least a portion of the service time range of the preset identity verification information, the processing device may proceed to operation 830. In response to that the current time is not within the service time range of each of at least a portion of the preset identity verification information, the processing device may proceed to perform operation 860 to refuse the operation requested by the operation request.

In 830, the processing device may determine whether the state of the preset identity verification information is the enabled state. The processing device may determine whether the state of each of at least a portion of all the preset identity verification information is the enabled state. In response to that the state of each of at least a portion of all the preset identity verification information is the enabled state, the processing device may proceed to operation 840. In response to that the state of each of at least a portion of all the preset identity verification information is not the enabled state, the processing device may proceed to perform operation 860 to refuse the operation requested by the operation request.

In 840, the processing device may determine whether a function of the preset identity verification information is consistent with a function requested by the operation request. As used herein, the function of the preset identity verification information is consistent with the function requested by the operation request means that the function of the preset identity verification information is the same as the function requested by the operation request, or the function requested by the operation request is included in the function of the preset identity verification information. As used herein, the function requested by the operation request may also be referred to as an operation requested by the operation request. Take unlocking as an example, if the function of the preset identity verification information is unlocking, and the function requested by the operation request is also unlocking, it means that the two functions are consistent. Otherwise, it means that the two functions are inconsistent. If the functions of the preset identity verification information include unlocking and alarming, and the function requested by the operation request is alarming, it also means that the two functions are consistent. Otherwise, it means that the two functions are inconsistent. In response to that the two functions are consistent, the processing device may proceed to perform operation 850. In response to that the two functions are inconsistent, the processing device may proceed to operation 860 to refuse the operation requested by the operation request.

In 850, the processing device may perform the operation requested by the operation request. In some embodiments, the operations 820, 830, and 840 may be performed simultaneously to verify the preset identity verification information corresponding to the operation request. When conditions including the receiving time of the operation request being within the service time range of the preset identity verification information, the state of the preset identity verification information being the enabled state, and the function of the preset identity verification information being consistent with the function requested by the operation request as described in operations 820, 830, and 843 are satisfied, the operation request may be responded and the function requested by the operation request may be performed. In some embodiments, one or two of the operations 820, 830, and 840 may be omitted. When one or more conditions described in operations among 820, 830, and 840 not omitted are satisfied, the operation request may also be responded and the function requested by the operation request.

In 860, the processing device may refuse the operation requested by the operation request. In some embodiments, the operations 820, 830, and 840 may be performed simultaneously to verify the preset identity verification information corresponding to the operation request. If the conditions are not satisfied simultaneously (e.g., the receiving time of the operation request being not within the service time range of the preset identity verification information, the state of the preset identity verification information being the disabled state, or the function of the preset identity verification information being inconsistent with the function requested by the operation request), the processing device may forbid to respond to the operation request and not perform the function requested by the operation request. In some embodiments, one or two operations of 820, 830, and 840 may be omitted. Therefore, when one or more conditions described in operations are not omitted among operations 820, 830, and 840 are not satisfied, the operation request may also not be responded and the function requested by the operation request may not be performed.

Taking unlocking using a fingerprint as an example, a function requested by an operation request including fingerprint information may be unlocking. Correspondingly, in order to allow the fingerprint information to be used to unlocking, the permission information corresponding to the preset identity verification information may be that a function of the preset identity verification information includes unlocking, a state of the preset identity verification information is an enabled state, and a service time range of the preset identity verification information includes a receiving time of the operation request. After obtaining the operation request including biometric information, unlocking may be allowed. In order to forbid unlocking using the biometric information (i.e., forbid responding to the operation request), at least one of the function, state, and service time range of the preset identity verification information may be modified or updated. In this way, a purpose of forbidding unlocking using the biometric information may be achieved, and the preset identity verification information that matches the biometric information may be not inputted repeatedly, which may reduce the difficulty of managing the identity information.

It should be noted that the above description of the process 800 is merely provided for the purposes of illustration, and not intended to limit the scope of the present disclosure. For persons having ordinary skills in the art, multiple variations and modifications on the process 800 may be made under the teachings of the present disclosure. For example, an order of operations 820, 830, and 840 may be modified. As another example, one or two of operations 820, 830, and 840 may be omitted. However, those variations and modifications do not depart from the scope of the present disclosure.

FIG. 9 is a schematic flowchart illustrating an exemplary process for updating permission information of identity verification information according to some embodiments of the present disclosure. In some embodiments, the process 900 may be executed by the server 110. For example, at least a portion of the process 800 may be stored in the storage device 150 in a form of instructions that may be retrieved and/or executed by the server 110. In some embodiments, a portion of the process 800 may be implemented on a terminal device. The process 900 may include the following operations.

In 910, the processing device 112 may obtain preset identity verification information of one or more authorized users. In some embodiments, when one or more conditions associated with the preset identity verification information are satisfied (e.g., the conditions shown in FIG. 8), the preset identity verification information of one or more authorized users may be obtained. Alternatively, a portion of all the preset identity verification information of the one or more authorized users may be obtained. In some embodiments, only the preset identity verification information that matches identity verification information of an operator as described in FIG. 7 may be obtained. The server 110 may obtain all the preset identity verification information from an internal storage device (e.g., the storage device 150) of the information processing system 100 or an external storage. While obtaining the preset identity verification information, permission information corresponding to each of all the preset identity verification information of the one or more authorized users may also be obtained. The permission information may include a service time range, a function, and a state of the identity verification information.

In 920, the processing device 112 may determine whether a current time is within a service time range of the preset identity verification information. In some embodiments, the processing device 112 may determine whether the current time is within the service time range of each of all the preset identity information obtained in operation 910. As described above, the preset identity information may include the permission information. The permission information may include the service time range of the preset identity information. An authorized user may have permission to use the object within the service time range. If the current time exceeds the service time range, the authorized user may lose the permission. The current time may be obtained from various sources. For example, the current time may be obtained from an external information source. In some embodiments, the service time range may be a continuous time range, for example, from Jan. 1, 2018, to Dec. 31, 2018. In some embodiments, the service time range may also be composed of several discontinuous time intervals. For example, an authorized user may have permission to use an object only on weekends, but not on weekdays. For instance, the service time range is May 4-5, 2019, May 11-12, 2019, and May 18-19, 2019. The processing device 112 may determine whether the current time exceeds a deadline (e.g., the end time) of the service time range of each of at least a portion of all the preset identity verification information. If the current time exceeds the deadline (e.g., the end time) of the service time range, it may be determined that the current time is not within the service time range of each of at least a portion of the preset identity verification information. The service time range may be defined by month, day, minute, second, etc. For example, a lease period of a public rental housing rent by an authorized user may be from May 17, 2018, to May 16, 2019.

The lease period may be a service time range of the identity verification information of the authorized user. If the current time is May 17, 2019, which is beyond the service time range of the identity verification information of the authorized user, it may indicate that the lease period of the authorized user has expired. If the current time is not within the service time range of the preset identity verification information, the processing device 112 may proceed to perform operation 930. If the current time is within the service time range of the preset identity verification information, the processing device 112 may proceed to perform operation 940.

In 930, the processing device 112 may update the state of the preset identity verification information to a disabled state. As used herein, the disabled state refers to that an authorized user corresponding to the preset identity verification information loses permission to use the object, and the authorized user may not continue to use the object. By setting the state of the preset identity verification information to the disabled state, a usage permission of the user may be stopped without deleting the preset identity verification information, and the state may be modified back to an enabled state in the future as appropriate to restore the usage permission of the user.

In 940, the processing device 112 may maintain the permission information of the preset identity verification information. In the case that the current time is within the service time range of the preset identity verification information, the permission information of the preset identity verification information may be maintained without modification.

It should be noted that the above description of the process 900 is merely provided for the purposes of illustration, and not intended to limit the scope of the present disclosure. For persons having ordinary skills in the art, multiple variations and modifications on the process 900 may be made under the teachings of the present disclosure.

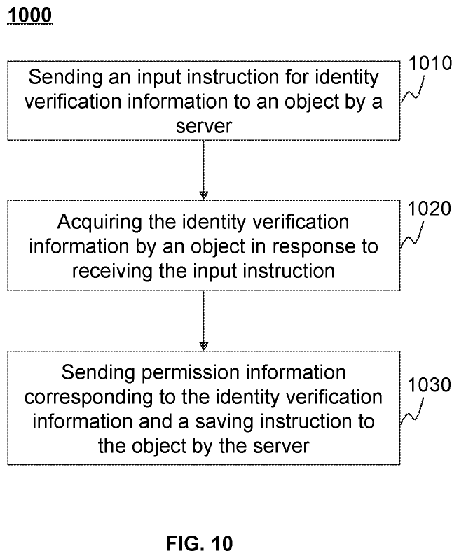

FIG. 10 is a schematic flowchart illustrating an exemplary process for generating permission information according to some embodiments of the present disclosure. In some embodiments, the process 1000 may be executed by the server 110 and/or the object 130. For example, the server 110 may store a set of instruction in a storage device. When executing the set of instructions, the processing device 112 and/or the object 130 may be caused to perform at least a portion of the process 1000. The process 1000 may include the following operations.

In 1010, the server 110 may send an input instruction for identity verification information to an object (also referred to as a target object). In some embodiments, an administrator of the object may operate on a client to register a new authorized user. After receiving registration information, the server 110 may generate the input instruction for identity verification information, and send the input instruction to the object corresponding to the user information of the authorized user. The registration information may include identity information of the authorized user and/or identification information of the object.

In 1020, the object may acquire the identity verification information of an operator of the object in response to receiving the input instruction. After receiving the input instruction for identity verification information sent by the server 110, the object may start to acquire the identity verification information. The identity verification information may include biometric information and/or a digital password, such as fingerprint information, etc., which may be acquired by a fingerprint acquisition device. In some embodiments, the same authorized user may be acquired multiple times to synthesize final identity verification information. For example, the fingerprint information may be acquired multiple times to synthesize the final fingerprint information. More descriptions regarding the acquisition of the identity verification information may be found in FIG. 2 and the descriptions thereof, which may not be repeated herein.

In 1030, the server 110 may send permission information corresponding to the identity verification information and a saving instruction to the object. In some embodiments, the object (e.g., a processing device) may send the acquired identity verification information to the server 110. The server 110 may determine whether the acquired identity verification information satisfies one or more conditions, such as whether the acquired identity verification information is enough (e.g., data amount exceeding a threshold, data types satisfies a preset type), whether the acquired identity verification information matches preset identity verification information of an authorized user of the object stored in the server 110, etc. For example, the server 110 may obtain a corresponding relationship between an object information of the object and the preset identity verification information of the authorized user of the object. The server 110 may determine the preset identity verification information of the authorized user of the object based on the corresponding relationship and the object information of the object. In response to determining that the identity verification information of the operator matches the preset identity verification information of the authorized user of the object, the server 10 may determine permission information corresponding to the preset identity verification information and send the permission information to the object.

The object may save the acquired identity verification information and the corresponding permission information in response to receiving the save instruction from the sent. For instance, the object may include a local storage device, and the input identity verification information and the corresponding permission information may be stored locally on the object. The saved identity verification information and the corresponding permission information may be used to verify identity verification information of one or more operators of the object. For example, a door lock of a room may locally store the input fingerprint information of the authorized user and the permission information of the authorized user. Therefore, when an operator attempts to swipe a fingerprint to open the door lock, the door lock may verify information of the operator based on the preset identity verification information of the authorized user and/or the permission information. If the information of the operator passes the verification, the door lock may be opened. More descriptions regarding that the object verifies the information of the operator may be found in FIG. 2 and the description thereof, which will not be repeated herein.

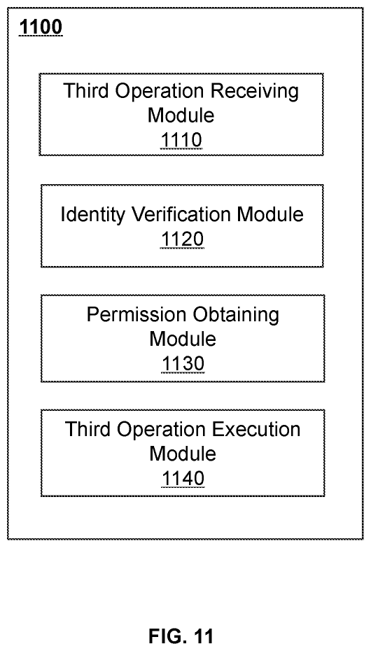

FIG. 11 is a block diagram illustrating an information processing system according to some embodiments of the present disclosure. The system 1100 may include a third operation receiving module 1110, an identity verification module 1120, a permission obtaining module 1130, and a third operation execution module 1140. In some embodiments, the system 1100 may be implemented on the server 110.

The third operation receiving module 1110 may be configured to receive information, such as an operation request including identity verification information of an operator. In some embodiments, the identity verification information of the operator may include biometric information of the operator (also referred to as biometric password) and/or a digital password. The biometric information of the operator may include one or more inherent physiological characteristics, one or more behavioral characteristics of the operator. In some embodiments, the operation request may include the identity verification information of the operator, and the operation request may be bound to an information acquisition device for acquiring the identity verification information of the operator. Therefore, after the information acquisition device is triggered to acquire the identity verification information of the operator input by the operator, the operation request may be automatically bound to the identity verification information acquired by the information acquisition device, and the operation request including the identity verification information of the operator input by the operator may be sent to the server 110 or the object 130.

The identity verification module 1120 may be configured to verify the identity verification information of the operator. In some embodiments, the identity verification module 1120 may determine whether there is preset identity verification information that matches the identity verification information of the operator. If there is the preset identity verification information that matches the identity verification information of the operator, the identity of the operator may be verified and the preset identity verification information may be obtained.

The permission obtaining module 1130 may be configured to obtain permission information of the identity verification information. For example, after the identity verification module 1120 determines the preset identity verification information that matches the information of the operator, the permission obtaining module 1130 may obtain the permission information of the preset identity verification information. The permission information may be configured to define a function (e.g., a permission range) of the identity verification information, a service time range of the identity verification information, a state of the identity verification information, or the like, or any combination thereof. For instance, the function of the preset identity verification information may be configured to indicate which operations the user is able or permitted to perform on an object the preset identity verification information may correspond to. For example, the function of the preset identity verification information may indicate unlocking, alarming, or the like, or any combination thereof. The service time range of the preset identity verification information may indicate a start time and an end time of the preset identity verification information. The state of the preset identity verification information may indicate whether the preset identity verification information is available. For example, when the state of the preset identity verification information is an enabled state, it may indicate that the preset identity verification information is available. If the state of the preset identity verification information is a disabled state, it may indicate that the preset identity verification information is unavailable.

The third operation execution module 1140 may be configured to process an operation request of the operator. In some embodiments, if the identity verification module 1120 verifies the identity verification information of the operator, the third operation execution module 1140 may execute an operation requested by the operation request of the operator. If the identity verification module 1120 fails to verify the identity verification information of the operator, the operation requested by the operation request may be refused. In some embodiments, the third operation execution module 1140 may perform the operation requested by the operation request of the operator in response to determining that one or more condition is satisfied based on the permission information corresponding to the preset identity verification information. The one or more conditions may include that the time for receiving the operation request is within the service time range of the identity verification information, the state of the identity verification information of the authorized user is an enabled state, the function of the identity verification information includes a function corresponding to an operation requested by the operation request, or the like, or a combination thereof.

The system 1100 may also include a permission information update module (not shown) to update the permission information of the preset identity information. The permission information may be updated automatically. Alternatively, the permission information may be updated through an external instruction.

It should be understood that the information processing system and the modules thereof shown in FIG. 11 may be implemented in various manners. For example, in some embodiments, the system and the modules thereof may be implemented by hardware, software, or a combination of software and hardware. As used herein, the hardware part may be realized by dedicated logic. The software part may be stored in a storage and executed by an appropriate instruction to execute systems, such as a microprocessor or dedicated design hardware. Those skilled in the art may understand that the above methods and systems may be implemented using computer-executable instructions and/or included in processor control codes. For example, the codes may be provided on such as a carrier medium (e.g., a disk, a CD, or a DVD-ROM), a programmable memory of a read-only memory (firmware), or a data carrier (e.g., an optical or electronic signal carrier). The system and the modules thereof of the present disclosure may be implemented by hardware circuits such as very large-scale integrated circuits or gate arrays, semiconductors (e.g., logic chips, transistors, etc.), programmable hardware devices (e.g., field-programmable gate arrays, programmable logic devices, etc.), various types of processors, or the like, or any combination thereof.

It should be noted that the above description of the information processing system 1100 and the modules thereof are merely provided for the purposes of illustration, and not intended to limit the scope of the present disclosure. It should be understood that for persons having ordinary skills in the art, after understanding the principle of the system, it may be possible to arbitrarily combine various modules, or form subsystems to connect with other modules without departing from the principle. For example, in some embodiments, the third operation receiving module 1110, the identity verification module 1120, the permission obtaining module 1130, and the third operation execution module 1140 disclosed in FIG. 11 may be different modules in a system, or may be one module that may realize the functions of the two or more modules mentioned above. Each module in the information processing system 1100 may share a storage module. Alternatively, each module may also have its own storage module. Those variations do not depart from the scope of the present disclosure.

The possible beneficial effects of the embodiments of the present disclosure may include, but not be limited to the following. (1) An object administrator may realize unified management of multiple objects, thereby ensuring consistency between an actual user/operator of the object and an authorized user, and excluding other people who have no permission to use the object. (2) Setting permissions for identity verification information may determine personalized usage plans for different users. (3) It may be possible to control whether to respond to an operation request of the user by modifying permission information corresponding to the identity verification information, so that there is no need to repeatedly input the identity verification information and reduce management difficulty of the identity verification information. It should be noted that different embodiments may have different beneficial effects. In different embodiments, the possible beneficial effects may be any one or a combination thereof, or any other beneficial effects that may be obtained.

Having thus described the basic concepts, it may be rather apparent to those skilled in the art after reading this detailed disclosure that the foregoing detailed disclosure is intended to be presented by way of example only and is not limiting.

Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer-readable media having computer-readable program code embodied thereon.

A non-transitory computer-readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python, or the like, conventional procedural programming languages, such as the “C” programming language, Visual Basic, Fortran, Perl, COBOL, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1-12. (canceled)

13. A system for information processing, comprising:
a computer-readable storage medium storing executable instructions; and
at least one processor in communication with the computer-readable storage medium, when executing the executable instructions, the at least one processor is caused to perform operations including:
obtaining user information of a target authorized user of a target object sent by a server;
receiving an operation request of an operator associated with the target object and information of the operator; and
verifying the information of the operator based on the user information of the target authorized user; and
processing the operation request based on a verification result, wherein the user information of the target authorized user is determined by the server based on a corresponding relationship between object information of at least one object and user information of at least one authorized user.

14. The system for information processing of claim 13, wherein the user information of the target authorized user includes identity verification information of the target authorized user.

15. The system for information processing of claim 14, wherein the identity verification information includes at least one of biometric information or digital password information.

16. The system for information processing of claim 14, wherein the information of the operator includes identity verification information of the operator; and
the verifying the information of the operator based on the user information of the target authorized user and processing the operation request based on a verification result includes:
verifying whether the identity verification information of the operator matches the identity verification information of the target authorized user; and
in response to that the identity verification information of the operator matches the identity verification information of the target authorized user, executing an operation associated with the target object requested by the operation request.

17. The system for information processing of claim 14, wherein the information of the operator includes identity verification information of the operator; and
the verifying the information of the operator based on the user information of the target authorized user and processing the operation request based on a verification result includes:
verifying whether the identity verification information of the operator matches the identity verification information of the target authorized user;
in response to that the identity verification information of the operator does not match the identity verification information of the target authorized user, determining whether a count of times the operation request of the operator is consecutively received exceeds a count threshold;
in response to that the count of times does not exceed the count threshold, continuing to receive the operation request of the operator and the information of the operator, and verify the information of the operator based on the user information of the authorized user;
in response to that the count of times exceeds the count threshold, generating operation failure information and stopping responding to the operation request of the operator.

18. The system for information processing of claim 17, wherein the processing the operation request based on a verification result further includes:
in response to that the count of times the operation request of the operator is consecutively received exceeds the count threshold, generating alarm information.

19. The system for information processing of claim 14, wherein the user information of the target authorized user further includes permission information, the permission information being configured to define at least one of a function of the identity verification information, a service time range of the identity verification information, or a state of the identity verification information.

20. The system for information processing of claim 19, wherein
the information of the operator includes identity verification information of the operator; and
the verifying the information of the operator based on the user information of the target authorized user and processing the operation request based on a verification result includes:
verifying whether the identity verification information of the operator-of the operator matches the identity verification information of the target authorized user; and
in response to that the identity verification information of the operator-of the operator matches the identity verification information of the target authorized user, processing the operation request based on the permission information of the target authorized user.

21. The system for information processing of claim 20, wherein the processing the operation request based on the permission information of the target authorized user includes executing the operation requested by the operation request when at least one of conditions is satisfied that:
a receiving time of the operation request is within the service time range of the identity verification information of the target authorized user;
the state of the identity verification information of the target authorized user is an enabled state; or
the function of the identity verification information of the target authorized user includes a function corresponding to an operation requested by the operation request.

22. The system for information processing of claim 13, wherein the target object includes a lockset and the operation request includes an unlocking request.

23. The system for information processing of claim 22, wherein the object includes a building.

24. The system for information processing of claim 13, wherein the object information of the at least one object includes an object identification.

25-42. (canceled)

43. A system for information processing, comprising:
a computer-readable storage medium storing executable instructions; and
at least one processor in communication with the computer-readable storage medium, when executing the executable instructions, the at least one processor is caused to perform operations including:
receiving an operation request of an operator associated with a target object, the operation request including identity verification information of the operator;
determining that preset identity verification information of a target authorized user of the target object matches the identity verification information of the the operator;
obtaining permission information of the preset identity verification information, the permission information being configured to define at least one of a function of the preset identity verification information, a service time range of the preset identity verification information, or a state of the preset identity verification information; and
processing the operation request based on the permission information of the preset identity verification information.

44. The system for information processing of claim 43, wherein the processing the operation request based on the permission information of the preset identity verification information includes executing an operation requested by the operation request when at least one of conditions is satisfied that:
a receiving time of the operation request is within the service time range of the matched preset identity verification information;
the state of the preset identity verification information is an enabled state; or
the function of the preset identity verification information includes a function corresponding to an operation requested by the operation request.

45. The system for information processing of claim 43, wherein the user identity verification information includes at least one of biometric information or digital password information.

46. The system for information processing of claim 43, wherein the method operations further include:
receiving pending permission information of the preset identity verification information;
determining whether the pending permission information satisfies a preset requirement;
in response to that the pending permission information satisfies the preset requirement, determining the pending permission information to be the permission information of the preset identity verification information.

47. The system for information processing of claim 43, wherein the operations further include:
determining whether a current time is within the service time range of the preset identity verification information; and
in response to that the current time is not within the service time range of the preset identity verification information, updating the state of the preset identity verification information to be a disabled state.

48-82. (canceled)

83. The system for information processing of claim 43, wherein the processing the operation request based on the permission information of the preset identity verification information includes:
updating at least a portion of at least one of the preset identity verification information or the permission information of the preset identity verification information of the target authorized user.

84. The system for information processing of claim 83, wherein the updating at least a portion of at least one of the preset identity verification information or the permission information of the preset identity verification information of the target authorized user includes:
verifying whether the operator has a permission to update the permission information of the preset identity verification information and the preset identity verification information of the target authorized user;
in response to that the operator has the permission, deleting at least a portion of at least one of the preset identity verification information or the permission information of the preset identity verification information of the target authorized user; and
acquiring at least a portion of at least one of new identity verification information of the target authorized user or new permission information of the identity verification information of the target authorized user.

85. A system for information processing, comprising:
a computer-readable storage medium storing executable instructions; and
at least one processor in communication with the computer-readable storage medium, when executing the executable instructions, the at least one processor is caused to perform operations including:
obtaining preset identity verification information of a target authorized user of a target object;
obtaining permission information of the preset identity verification information, the permission information being configured to define at least one of a function of the preset identity verification information, a service time range of the preset identity verification information, or a state of the preset identity verification information;
determining whether the permission information of the preset identity verification information satisfies one or more conditions;
in response to determining that the permission information of the preset identity verification information does not satisfy at least one of the one or more conditions, updating at least a portion of the permission information; and
processing an operation request associated with the target object based on the updated permission information of the preset identity verification information.
